(19) United States
(12) Patent Application Publication
(10) Pub. No.: US 2025/0331053 A1
(43) Pub. Date: Oct. 23, 2025

(54) COMMUNICATION METHOD AND APPARATUS

(71) Applicant: HUAWEI TECHNOLOGIES CO., LTD., Shenzhen (CN)

(72) Inventors: Dongdong WEI, Shenzhen (CN); Fan WANG, Shanghai (CN); Zhang ZHANG, Shanghai (CN); Qi FENG, Shanghai (CN)

(73) Assignee: HUAWEI TECHNOLOGIES CO., LTD., Shenzhen (CN)

(21) Appl. No.: 19/252,136

(22) Filed: Jun. 27, 2025

Related U.S. Application Data
(63) Continuation of application No. PCT/CN2022/143553, filed on Dec. 29, 2022.

(51) Int. Cl. H04W 76/20; H04W 56/00; H04W 68/02; H04W 74/0833

(52) U.S. Cl. CPC H04W 76/20; H04W 56/0015; H04W 68/02; H04W 74/0833

(57) ABSTRACT

This application provides a communication method and apparatus for reducing energy consumption while maintaining normal communication of a network apparatus. In the method, a terminal apparatus obtains operation mode information of a network apparatus, where an operation mode of the network apparatus includes one of a first operation mode or a second operation mode, and the first operation mode and the second operation mode belong to a same radio access technology. In the first operation mode, a transmission resource for a synchronization signal of the network apparatus has lower overheads or supports fewer functions. Alternatively, an access procedure in the first operation mode is different from an access procedure in the second operation mode. Based on the operation mode information, the terminal apparatus performs communication with the network apparatus by using the configuration information in one of the first operation mode and the second operation mode.

### CROSS-REFERENCE TO RELATED APPLICATIONS

This application is a continuation of International Application No. PCT/CN2022/143553, filed on Dec. 29, 2022, the disclosure of which is hereby incorporated by reference in its entirety.

### TECHNICAL FIELD

This application relates to the field of mobile communication technologies, and in particular, to a communication method and apparatus.

### BACKGROUND

To meet increasing traffic requirements on wireless communication, new wireless networks are being rapidly constructed and developed. As the network scale becomes larger, energy consumption of network side devices such as an access network device and a core network device continuously increases. To reduce energy consumption by an access network device, the 3rd generation partnership project (3GPP) supports a shutdown technology for access network devices such as a base station in a 5th generation (5G) mobile communication new radio (NR) system. In addition, an access network device may also enable a cell to be in an operating state or a shutdown state through activation or deactivation, to reduce network energy consumption.

However, regardless of the shutdown technology for access network devices or an activation and deactivation technology for cells, the energy consumption by an access network device is reduced at the cost of completely stopping communication. Therefore, a solution that reduces energy consumption and still maintains communication transmission performance is to be proposed.

### SUMMARY

This application provides a communication method and apparatus, to reduce energy consumption of a network apparatus and ensure that the network apparatus can perform normal communication.

According to a first aspect, this application provides a communication method. The method may be implemented by a terminal apparatus. The terminal apparatus may also be referred to as a first communication apparatus. The terminal apparatus may be a terminal device or a component in a terminal device. The component in this application may include, for example, at least one of a chip, a chip system, a processor, a transceiver, a processing unit, or a transceiver unit. An example in which an execution body is the terminal apparatus is used. The method may be implemented by using the following steps. The terminal apparatus obtains operation mode information of a network apparatus. An operation mode of the network apparatus includes one of a first operation mode or a second operation mode. The first operation mode and the second operation mode belong to a same radio access technology (RAT). The first operation mode and the second operation mode satisfy at least one of the following: overheads of a transmission resource for a synchronization signal of the network apparatus in the first operation mode are lower than overheads of a transmission resource for a synchronization signal of the network apparatus in the second operation mode; a function supported by the network apparatus in the first operation mode is a proper subset of a function supported by the network apparatus in the second operation mode; or an access procedure in the first operation mode is different from an access procedure in the second operation mode. Based on the operation mode information, the terminal apparatus performs communication with the network apparatus by using configuration information in one of the first operation mode and the second operation mode.

According to the method shown in the first aspect, the network apparatus may operate in the first operation mode or the second operation mode, and the terminal apparatus may learn a current operation mode of the network apparatus based on the operation mode information and perform communication with the network apparatus by using configuration information in the current operation mode of the network apparatus. The energy consumption of the network apparatus in the first operation mode is lower than energy consumption of the network apparatus in the second operation mode. Therefore, energy consumption of the network apparatus can be reduced.

In a possible implementation, the function supported by the network apparatus in the second operation mode includes at least one of the following: a dual active protocol stack, conditional handover, two-step random access, small data transmission, a reduced capability, vehicle-to-everything, a multicast broadcast service, slicing, an industrial internet of things, extended reality, uplink data compression, positioning, ultra-reliable low-latency communication, high-order modulation, grant-free scheduling, sensing, artificial intelligence, unlicensed spectrum transmission, multi-layer transmission, or non-slot scheduling.

In a possible implementation, the terminal apparatus may further receive configuration information in the first operation mode and/or configuration information in the second operation mode from the network apparatus.

Based on this implementation, the terminal apparatus may obtain, from the network apparatus, configuration information in the operation mode of the network apparatus for communication.

In a possible implementation, the operation mode information includes at least one of the following: first information indicating one of the first operation mode and the second operation mode; or second information related to switching of the operation mode of the network apparatus.

Based on this implementation, the terminal apparatus may learn the operation mode of the network apparatus based on the second information related to the switching of the operation mode or the first information indicating the current operation mode. Therefore, the terminal apparatus can flexibly ascertain the operation mode of the network apparatus.

In a possible implementation, the second information may include at least one of the following information: a cycle and a duration of the first operation mode; a cycle and a duration of the second operation mode; or information indicating operation mode switching.

According to this implementation, the terminal apparatus may flexibly determine that the operation mode of the network apparatus has been switched. For example, in a scenario in which the operation mode is periodically changed, the terminal apparatus may determine the current operation mode based on a cycle and/or a duration, so that the cycle and/or the duration may be indicated once by using signaling, which can reduce signaling overheads. For another example, the terminal apparatus may determine operation mode switching based on a switching indication sent by the network apparatus, and determine, based on the operation mode before switching, an operation mode after switching. In this manner, the operation mode of the network apparatus may be changed more flexibly, to support an aperiodic operation mode change.

In a possible implementation, the operation mode information may be carried in one or more of group downlink control information (DCI), a paging message, a short message, or a system information block (SIB).

Based on this implementation, the network apparatus may send the operation mode information by using the group DCI, the paging message, the short message, or the SIB, to support a plurality of UEs in learning the switching of the operation mode based on a same message or information.

In a possible implementation, a modulation and coding scheme (MCS) table associated with the first operation mode is different from a modulation and coding scheme (MCS) table associated with the second operation mode; and/or a channel quality information (CQI) table associated with the first operation mode is different from a channel quality information (CQI) table associated with the second operation mode.

Based on this implementation, the first operation mode and the second operation mode may be associated with different MCS tables and/or CQI tables, to adapt to performance in different operation modes.

In a possible implementation, the terminal apparatus may further perform, after the first duration starting when the terminal apparatus determines that the operation mode of the network apparatus is to be switched, communication with the network apparatus by using the configuration information in the operation mode being switched to.

Based on this implementation, data transmission is stopped for a short time period in the first duration during the switching the operation mode of the network apparatus, to avoid a transmission failure and improve a transmission success rate.

In a possible implementation, the first duration is related to a system parameter numerology within an operating bandwidth of the terminal apparatus.

Based on this implementation, the first duration may be flexibly configured based on the numerology, to avoid excessively long interruption time.

In a possible implementation, the first duration is included in the switching indication for the operation mode of the network apparatus.

Based on this implementation, the network apparatus may indicate the first duration, to avoid a transmission failure caused by interruption of transmission by the terminal apparatus and the network apparatus in a different duration, that is, avoid a transmission failure caused by time asynchronization of interruption of transmission. Therefore, the transmission success rate can be improved.

In a possible implementation, the terminal apparatus receives a first synchronization signal, where the first synchronization signal corresponds to the first operation mode; and the terminal apparatus initiates random access based on the first synchronization signal. Alternatively, the terminal apparatus receives a second synchronization signal, where the second synchronization signal corresponds to the second operation mode; and the terminal apparatus initiates random access based on the second synchronization signal. The sequence length of the first synchronization signal is less than the sequence length of the second synchronization signal; and/or a sequence type of the first synchronization signal is different from a sequence type of the second synchronization signal.

Based on this implementation, different access procedures may be used in the first operation mode and the second operation mode. For example, the access procedure (or a synchronization signal sending process) in the first operation mode may consume less energy.

In a possible implementation, the terminal apparatus may further determine the operation mode information based on the first synchronization signal. Alternatively, the terminal apparatus may further determine the operation mode information based on the second synchronization signal.

Based on this implementation, the terminal apparatus may distinguish the operation mode of the network apparatus based on the first synchronization signal and the second synchronization signal. In this case, no additional signaling or information is needed to indicate the current operation mode or indicate the operation mode change. Therefore, the signaling overheads can be reduced.

In a possible implementation, the terminal apparatus may perform downlink synchronization based on the first synchronization signal. The terminal apparatus sends a first message to the network apparatus. The first message is used to request the network apparatus to send a master information block (MIB) and system information. The terminal apparatus receives the master information block and the system information from the network apparatus. The master information block includes an access configuration. The system information includes a random access resource configuration. The terminal apparatus sends a random access request to the network apparatus based on the access configuration and the random access resource configuration.

Based on this implementation, in the first operation mode, the network apparatus may send the master information block and the system information based on the first message, without a need to periodically send the master information block and the system information, so that the energy consumption is reduced.

In a possible implementation, the terminal apparatus performs downlink synchronization based on the second synchronization signal. The terminal apparatus receives a master information block and system information from the network apparatus. The master information block includes an access configuration. The system information includes a random access resource configuration. The terminal apparatus sends a random access request to the network apparatus based on the access configuration and the random access resource configuration.

Based on this implementation, the network apparatus may periodically send the master information block and the system information in the second operation mode, so that access efficiency is improved.

In a possible implementation, the terminal apparatus sends auxiliary information or a signal associated with the auxiliary information to the network apparatus. The auxiliary information is used by the network apparatus to determine the operation mode. The auxiliary information includes at least one of the following: information about an operation mode expected by the terminal apparatus, a request for the operation mode, service requirement information, quality of service information of a service, or communication performance requirement information.

Based on this implementation, the network apparatus may determine the operation mode based on the auxiliary information from the terminal apparatus, to meet a transmission requirement or request of the terminal apparatus.

According to a second aspect, this application provides a communication method. The method may be implemented by a network apparatus. The network apparatus may be a network device or a component in a network device. The network apparatus may also be referred to as a second communication apparatus. The second communication apparatus in this application may include, for example, at least one of a chip, a chip system, a processor, a transceiver, a processing unit, or a transceiver unit. The method may be implemented by using the following steps. The network apparatus may determine operation mode information. An operation mode of the network apparatus includes one of a first operation mode or a second operation mode. The first operation mode and the second operation mode belong to a same radio access technology (RAT). The first operation mode and the second operation mode satisfy at least one of the following: overheads of a transmission resource for a synchronization signal of the network apparatus in the first operation mode are lower than overheads of a transmission resource for a synchronization signal of the network apparatus in the second operation mode; a function supported by the network apparatus in the first operation mode is a proper subset of a function supported by the network apparatus in the second operation mode; or an access procedure in the first operation mode is different from an access procedure in the second operation mode. The network apparatus performs communication with a terminal apparatus based on the operation mode information by using configuration information in one of the first operation mode and the second operation mode.

In a possible implementation, the function supported by the network apparatus in the second operation mode includes at least one of the following: a dual active protocol stack, conditional handover, two-step random access, small data transmission, a reduced capability, vehicle-to-everything, a multicast broadcast service, slicing, an industrial internet of things, extended reality, uplink data compression, positioning, ultra-reliable low-latency communication, high-order modulation, grant-free scheduling, sensing, artificial intelligence, unlicensed spectrum transmission, multi-layer transmission, or non-slot scheduling.

In a possible implementation, the network apparatus may further send configuration information in the first operation mode and/or configuration information in the second operation mode.

In a possible implementation, the operation mode information includes at least one of the following: first information indicating one of the first operation mode and the second operation mode; or second information related to switching of the operation mode of the network apparatus.

In a possible implementation, the second information includes at least one of the following: a cycle and a duration of the first operation mode; a cycle and a duration of the second operation mode; or information indicating operation mode switching.

In a possible implementation, the operation mode information is carried in one or more of group downlink control information (DCI), a paging message, a short message, or a system information block (SIB).

In a possible implementation, a modulation and coding scheme (MCS) table associated with the first operation mode is different from a modulation and coding scheme (MCS) table associated with the second operation mode; and/or a channel quality information (CQI) table associated with the first operation mode is different from a channel quality information (CQI) table associated with the second operation mode.

In a possible implementation, the network apparatus may further perform, after the first duration that starts when the network apparatus determines to switch the operation mode, communication with the terminal apparatus by using configuration information in an operation mode that is switched to.

In a possible implementation, the first duration is determined based on a system parameter numerology within an operating bandwidth of the terminal apparatus.

In a possible implementation, the first duration is included in a switching indication for the operation mode of the network apparatus.

In a possible implementation, the network apparatus may further send a first synchronization signal or a second synchronization signal. The first synchronization signal corresponds to the first operation mode. The second synchronization signal corresponds to the second operation mode. The sequence length of the first synchronization signal is less than the sequence length of the second synchronization signal; and/or the sequence type of the first synchronization signal is different from the sequence type of the second synchronization signal.

In a possible implementation, the network apparatus may further receive a first message from the terminal apparatus. The first message is sent by the terminal apparatus after receiving the first synchronization signal. The first message is used to request the network apparatus to send system information. The network apparatus sends a master information block (MIB) and the system information to the terminal apparatus. The master information block includes an access configuration. The system information includes a random access resource configuration. The network apparatus receives a random access request from the terminal apparatus based on the access configuration and the random access resource configuration. The random access request is used to initiate random access.

In a possible implementation, the network apparatus may further send a master information block and system information to the terminal apparatus. The master information block includes an access configuration. The system information includes a random access resource configuration. The network apparatus receives a random access request from the terminal apparatus based on the access configuration and the random access resource configuration. The random access request is sent by the terminal apparatus after receiving the second synchronization signal. The random access request is used to initiate random access.

In a possible implementation, the network apparatus may further receive auxiliary information or a signal associated with the auxiliary information from the terminal apparatus. The network apparatus determines the operation mode of the network apparatus based on the auxiliary information. The auxiliary information includes at least one of the following information: information about an operation mode expected by the terminal apparatus, a request for the operation mode, service requirement information, quality of service information of a service, or communication performance requirement information.

In a possible implementation, the network apparatus may further receive, from a second network apparatus, operation mode information of the second network apparatus and/or operation mode configuration information of the second network apparatus.

According to a third aspect, a communication apparatus is provided. The apparatus may implement the method according to any possible design of the first aspect or the second aspect. The apparatus is configured with a function of the foregoing terminal apparatus and/or network apparatus. The apparatus is, for example, a terminal device, a functional module in a terminal device, a network device, or a functional module in a network device.

In an optional implementation, the apparatus may include modules that perform and that are in one-to-one correspondence with the method/operations/steps/actions described in the first aspect or the second aspect. The module may be implemented by a hardware circuit, software, or a combination of a hardware circuit and software. In an optional implementation, the apparatus includes a processing unit (sometimes also referred to as a processing module) and a communication unit (sometimes also referred to as a transceiver module, a communication module, or the like). The transceiver unit can implement a sending function and a receiving function. When the transceiver unit implements the sending function, the transceiver unit may be referred to as a sending unit (sometimes also referred to as a sending module). When the transceiver unit implements the receiving function, the transceiver unit may be referred to as a receiving unit (sometimes also referred to as a receiving module). The sending unit and the receiving unit may be a same functional module, the functional module is referred to as the transceiver unit, and the functional module can implement the sending function and the receiving function. Alternatively, the sending unit and the receiving unit may be different functional modules, and the transceiver unit is a general term for these functional modules.

When the method performed by the terminal apparatus in the first aspect is implemented, the processing unit may be configured to determine operation mode information of a network apparatus. An operation mode of the network apparatus includes one of a first operation mode or a second operation mode. The first operation mode and the second operation mode belong to a same radio access technology (RAT). The first operation mode and the second operation mode satisfy at least one of the following: overheads of a transmission resource for a synchronization signal of the network apparatus in the first operation mode are lower than overheads of a transmission resource for a synchronization signal of the network apparatus in the second operation mode; a function supported by the network apparatus in the first operation mode is a proper subset of a function supported by the network apparatus in the second operation mode; or an access procedure in the first operation mode is different from an access procedure in the second operation mode. The communication unit may be configured to perform communication with the network apparatus based on the operation mode information by using configuration information in one of the first operation mode and the second operation mode.

In a possible implementation, the function supported by the network apparatus in the second operation mode includes at least one of the following: a dual active protocol stack, conditional handover, two-step random access, small data transmission, a reduced capability, vehicle-to-everything, a multicast broadcast service, slicing, an industrial internet of things, extended reality, uplink data compression, positioning, ultra-reliable low-latency communication, high-order modulation, grant-free scheduling, sensing, artificial intelligence, unlicensed spectrum transmission, multi-layer transmission, or non-slot scheduling.

In a possible implementation, the communication unit may be further configured to receive configuration information in the first operation mode and/or configuration information in the second operation mode from the network apparatus.

In a possible implementation, the operation mode information includes at least one of the following: first information indicating one of the first operation mode and the second operation mode; or second information related to switching of the operation mode of the network apparatus.

In a possible implementation, the second information may include at least one of the following information: a cycle and a duration of the first operation mode; a cycle and a duration of the second operation mode; or information indicating operation mode switching.

In a possible implementation, the operation mode information may be carried in one or more of group downlink control information (DCI), a paging message, a short message, or a system information block (SIB).

In a possible implementation, a modulation and coding scheme (MCS) table associated with the first operation mode is different from a modulation and coding scheme (MCS) table associated with the second operation mode; and/or a channel quality information (CQI) table associated with the first operation mode is different from a channel quality information (CQI) table associated with the second operation mode.

In a possible implementation, the communication unit may be further configured to perform, after the first duration that starts when the processing unit determines that the operation mode of the network apparatus is to be switched, communication with the network apparatus by using configuration information in an operation mode that is switched to.

In a possible implementation, the first duration is related to a system parameter numerology within an operating bandwidth of the terminal apparatus.

In a possible implementation, the first duration is included in a switching indication of the operation mode of the network apparatus.

In a possible implementation, the communication unit may be further configured to: receive a first synchronization signal and initiate random access based on the first synchronization signal; or configured to receive a second synchronization signal and initiate random access based on the second synchronization signal. The sequence length of the first synchronization signal is less than the sequence length of the second synchronization signal; and/or the sequence type of the first synchronization signal is different from the sequence type of the second synchronization signal.

In a possible implementation, the processing unit may be further configured to determine the operation mode information based on the first synchronization signal, or determine the operation mode information based on the second synchronization signal.

In a possible implementation, the processing unit may be further configured to perform downlink synchronization based on the first synchronization signal. The communication unit may be further configured to: send a first message to the network apparatus, receive a master information block and system information from the network apparatus, and send a random access request to the network apparatus based on an access configuration and a random access resource configuration.

In a possible implementation, the processing unit may be further configured to perform downlink synchronization based on the second synchronization signal. The communication unit may be further configured to receive a master information block and system information, and send a random access request to the network apparatus based on an access configuration and a random access resource configuration.

In a possible implementation, the communication unit may be further configured to send auxiliary information or a signal associated with auxiliary information.

When the method performed by the network apparatus in the second aspect is implemented, the processing unit may be configured to determine the operation mode information of the network apparatus. An operation mode of the network apparatus includes one of a first operation mode or a second operation mode. The first operation mode and the second operation mode belong to a same radio access technology (RAT). The first operation mode and the second operation mode satisfy at least one of the following: overheads of a transmission resource for a synchronization signal of the network apparatus in the first operation mode are lower than overheads of a transmission resource for a synchronization signal of the network apparatus in the second operation mode; a function supported by the network apparatus in the first operation mode is a proper subset of a function supported by the network apparatus in the second operation mode; or an access procedure in the first operation mode is different from an access procedure in the second operation mode. The communication unit may be configured to perform communication with a terminal apparatus based on the operation mode information by using the configuration information in one of the first operation mode and the second operation mode.

In a possible implementation, the function supported by the network apparatus in the second operation mode includes at least one of the following: a dual active protocol stack, conditional handover, two-step random access, small data transmission, a reduced capability, vehicle-to-everything, a multicast broadcast service, slicing, an industrial internet of things, extended reality, uplink data compression, positioning, ultra-reliable low-latency communication, high-order modulation, grant-free scheduling, sensing, artificial intelligence, unlicensed spectrum transmission, multi-layer transmission, or non-slot scheduling.

In a possible implementation, the communication unit may be further configured to send configuration information in the first operation mode and/or configuration information in the second operation mode.

In a possible implementation, the operation mode information includes at least one of the following: first information indicating one of the first operation mode and the second operation mode; or second information related to switching of the operation mode of the network apparatus.

In a possible implementation, the second information includes at least one of the following: a cycle and a duration of the first operation mode; a cycle and a duration of the second operation mode; or information indicating operation mode switching.

In a possible implementation, the operation mode information is carried in one or more of group downlink control information (DCI), a paging message, a short message, or a system information block (SIB).

In a possible implementation, a modulation and coding scheme (MCS) table associated with the first operation mode is different from a modulation and coding scheme (MCS) table associated with the second operation mode; and/or a channel quality information (CQI) table associated with the first operation mode is different from a channel quality information (CQI) table associated with the second operation mode.

In a possible implementation, the communication unit may be further configured to perform, after the first duration that starts when the processing unit determines to switch the operation mode, communication with the terminal apparatus by using configuration information in an operation mode that is switched to.

In a possible implementation, the first duration is determined based on a system parameter numerology within an operating bandwidth of the terminal apparatus.

In a possible implementation, the first duration is included in a switching indication for the operation mode of the network apparatus.

In a possible implementation, the communication unit may be further configured to send a first synchronization signal and/or a second synchronization signal. The sequence length of the first synchronization signal is less than the sequence length of the second synchronization signal; and/or the sequence type of the first synchronization signal is different from the sequence type of the second synchronization signal.

In a possible implementation, the communication unit may be further configured to receive a first message and send a master information block and system information.

In a possible implementation, the communication unit may be further configured to receive a random access request.

In a possible implementation, the communication unit may be further configured to receive auxiliary information from the terminal apparatus, and the processing unit may be further configured to determine the operation mode of the network apparatus based on the auxiliary information.

According to a fourth aspect, an embodiment of this application further provides a communication apparatus including a processor configured to execute a computer program (or computer-executable instructions) stored in a memory. When the computer program (or the computer-executable instructions) is executed, the apparatus is enabled to perform the method according to the first aspect or the second aspect and the possible implementations of the first aspect or the second aspect.

In a possible implementation, the processor and the memory are integrated together.

In another possible implementation, the memory is located outside the communication apparatus.

The communication apparatus further includes a communication interface. The communication interface is for communication between the communication apparatus and another device, for example, for data and/or signal sending or receiving. For example, the communication interface may be a transceiver, a circuit, a bus, a module, or another type of communication interface.

According to a fifth aspect, an embodiment of this application further provides a terminal apparatus, configured to perform the method according to the first aspect and the possible implementations of the first aspect.

According to a sixth aspect, an embodiment of this application further provides a network apparatus, configured to perform the method according to the second aspect and the possible implementations of the second aspect.

According to a seventh aspect, a computer-readable storage medium is provided. The computer-readable storage medium is configured to store a computer program or instructions. When the computer program or the instructions are run, the method according to the first aspect or the second aspect and any possible implementation of the first aspect or the second aspect is implemented.

According to an eighth aspect, a computer program product including instructions is provided. When the computer program product is run on a computer, the method according to the first aspect or the second aspect and any possible implementation of the first aspect or the second aspect is implemented.

According to a ninth aspect, a chip system is provided. The chip system includes a logic circuit (which may alternatively be understood as that the chip system includes a processor, and the processor may include a logic circuit, and the like), and may further include an input/output interface. The input/output interface may be configured to input a message, or may be configured to output a message. The input/output interface may be a same interface. In other words, the same interface can implement both a sending function (e.g., transmission) and a receiving function (e.g., reception). Alternatively, the input/output interface includes an input interface and an output interface. The input interface is configured to implement a receiving function, that is, configured to receive a message. The output interface is configured to implement a sending function, that is, configured to send a message. The logic circuit may be configured to perform an operation other than the sending function and the receiving function in the method according to the first aspect or the second aspect and any possible implementation of the first aspect or the second aspect. The logic circuit may be further configured to transmit a message to the input/output interface, or receive, from the input/output interface, a message from another communication apparatus. The chip system may be configured to implement the method according to the first aspect or the second aspect and any possible implementation of the first aspect or the second aspect. The chip system may include a chip, or may include a chip and another discrete component.

Optionally, the chip system may further include a memory. The memory may be configured to store instructions. The logic circuit may invoke the instructions stored in the memory to implement a corresponding function.

According to a tenth aspect, a communication system is provided. The communication system may include a terminal apparatus and a network apparatus. The terminal apparatus may be configured to perform the method according to the first aspect and any possible implementation of the first aspect. The network apparatus may be configured to perform the method according to the second aspect and any possible implementation of the second aspect.

For technical effects brought by the second aspect to the tenth aspect, refer to the descriptions of the first aspect. Details are not described herein again.

### BRIEF DESCRIPTION OF DRAWINGS

FIG. 1 is a diagram of an architecture of a wireless communication system according to an embodiment of this application;

FIG. 2 is a schematic flowchart of a communication method according to an embodiment of this application;

FIG. 3 is a diagram of comparison between manners of sending a synchronization signal in different operation modes according to an embodiment of this application;

FIG. 4 is another diagram of comparison between manners of sending a synchronization signal in different operation modes according to an embodiment of this application;

FIG. 5 is a diagram of comparison between manners of enabling an antenna in different operation modes according to an embodiment of this application;

FIG. 6 is a diagram of an operation mode switching manner according to an embodiment of this application;

FIG. 7 is a diagram of another operation mode switching manner according to an embodiment of this application;

FIG. 8 is a diagram of a structure of a communication apparatus according to an embodiment of this application;

FIG. 9 is a diagram of a structure of another communication apparatus according to an embodiment of this application; and

FIG. 10 is a diagram of a structure of another communication apparatus according to an embodiment of this application.

### DESCRIPTION OF EMBODIMENTS

Embodiments of this application provide a communication method and apparatus. The method and an apparatus are based on a same inventive concept. Because the method and the apparatus have a similar problem-resolving principle, for implementations of the apparatus and the method, refer to each other, and no repeated descriptions are provided. In descriptions of embodiments of this application, the term “and/or” describes an association relationship between associated objects and indicates that three relationships may exist. For example, A and/or B may indicate the following three cases: Only A exists, both A and B exist, and only B exists. The character “/” generally indicates an “or” relationship between the associated objects. In this application, “at least one” means one or more, and “a plurality of” means two or more. In addition, it should be understood that in the descriptions of this application, terms such as “first” and “second” are merely for distinguishing and description, but should not be understood as indicating or implying relative importance, or should not be understood as indicating or implying a sequence.

The communication method provided in embodiments of this application may be applied to a 4th generation (4G) communication system, for example, a long term evolution (LTE) communication system, may be applied to a 5th generation (5G) communication system, for example, an NR communication system, or may be applied to various evolved communication systems after 5G, for example, a 6th generation (6G) communication system. The method provided in embodiments of this application may also be applied to a Bluetooth system or vehicle-to-everything (V2X) system. The method provided in embodiments of this application may also be applied to a satellite communication system. The satellite communication system may be integrated with the foregoing communication systems.

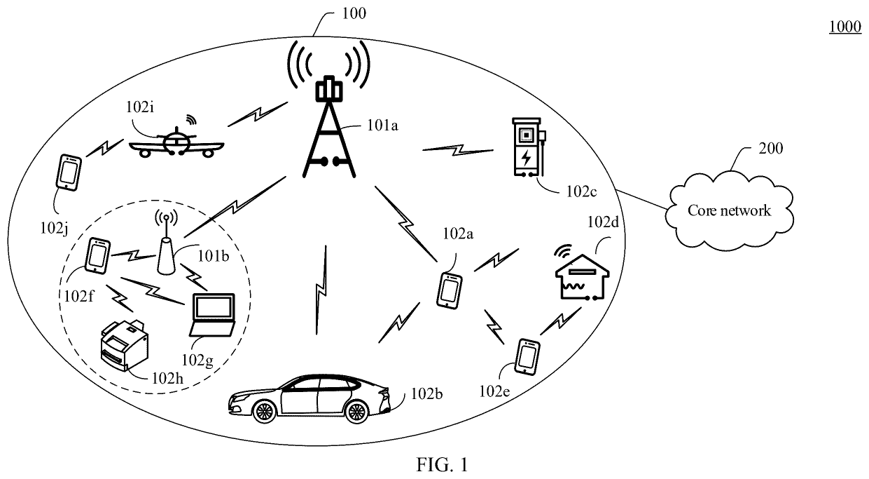

For ease of understanding embodiments of this application, an application scenario is described by using a communication system architecture shown in FIG. 1 as an example. FIG. 1 is a diagram of a possible and non-limiting example. As shown in FIG. 1, a communication system 1000 includes a radio access network (RAN) 100 and a core network (CN) 200. The RAN 100 includes at least one network device (for example, 101a and 101b in FIG. 1, which are collectively referred to as 110) and at least one terminal (for example, 102a to 102j in FIG. 1, which are collectively referred to as terminals 102). The RAN 100 may further include another RAN node, for example, a wireless relay device and/or a wireless backhaul device (not shown in FIG. 1). The terminal 102 is connected to the network device 101 in a wireless manner. The network device 101 is connected to the core network 200 in a wireless or wired manner. A core network device in the core network 200 and the network device 101 in the RAN 100 may be different physical devices, or may be a same physical device that integrates a logical function of the core network and a logical function of the radio access network.

The RAN 100 may be a related cellular system of the 3rd generation partnership project (3GPP), for example, a 4G mobile communication system, a 5G mobile communication system, or an evolved system after 5G (for example, a 6G mobile communication system). Alternatively, the RAN 100 may be an open access network (open RAN, O-RAN or ORAN), a cloud radio access network (CRAN), or a wireless fidelity (Wi-Fi) system. Alternatively, the RAN 100 may be a communication system that integrates two or more of the foregoing systems.

The apparatus provided in embodiments of this application may be used in the network device 101 or the terminal 102. It may be understood that FIG. 1 shows only one possible communication system architecture to which embodiments of this application may be applied. In another possible scenario, the communication system architecture may alternatively include another device.

The network device 101 is a node in the RAN, and may also be referred to as an access network device, or may also be referred to as a RAN node (or device). The network device 101 is configured to help the terminal implement radio access. A plurality of network devices 101 in the communication system 100 may be nodes of a same type, or may be nodes of different types. In some scenarios, roles of the network device 101 and the terminal 102 are relative. For example, a network element 102i in FIG. 1 may be a helicopter or an uncrewed aerial vehicle, and may be configured as a mobile base station. For the terminal 102j that accesses the RAN 100 via the network element 102i, the network element 102i is a base station, but for a base station 101a, the network element 102i is a terminal. The network device 101 and the terminal 102 are sometimes referred to as communication apparatuses. For example, the network elements 101a and 101b in FIG. 1 may be understood as communication apparatuses having a base station function, and the network elements 102a to 102j may be understood as communication apparatuses having a terminal function.

In a possible scenario, the network device may be a base station, an evolved NodeB (evolved NodeB, eNodeB) in 4G, an access point (AP), a transmission reception point (TRP), a next generation NodeB (gNB) in 5G, a base station in a 6th generation (6G) mobile communication system, a base station in a future mobile communication system, a satellite, an access node in the Wi-Fi system, or the like. The network device may be a macro base station (for example, 110a in FIG. 1), a micro base station or an indoor base station (for example, 110b in FIG. 1), a relay node or a donor node, or a radio controller in a cloud radio access network (C-RAN) scenario. Alternatively, the network device may be a device that functions as a base station in device-to-device (D2D) communication, vehicle-to-everything communication, or machine communication. Optionally, the network device may be a server, a wearable device, a vehicle, an in-vehicle device, or the like. For example, an access network device in a vehicle-to-everything (V2X) technology may be a roadside unit (RSU).

In another possible scenario, a plurality of network devices cooperate to assist the terminal in implementing radio access, and different network devices separately implement some functions of a base station. For example, the network device may be a central unit (CU), a distributed unit (DU), a CU-control plane (CP), a CU-user plane (UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand their meanings. For example, in an open RAN (O-RAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP and the CU-UP), the DU, and the RU in this application may be implemented by using a software module, a hardware module, or a combination of a software module and a hardware module.

The terminal 102 may also be referred to as a user equipment (UE), a mobile station (MS), a mobile terminal (MT), or the like, and is a device that provides a user with voice or data connectivity, or may be an internet of things (IoT) device. For example, the terminal device includes a handheld device, an in-vehicle device, or the like that has a wireless connection function. Currently, the terminal device may be a mobile phone, a tablet computer, a notebook computer, a palmtop computer, a mobile internet device (MID), a wearable device (for example, a smartwatch, a smart band, or a pedometer), an in-vehicle device (for example, a car, a bicycle, an electric vehicle, an airplane, a ship, a train, or a high-speed train), a virtual reality (VR) device, an augmented reality (AR) device, a smart point of sale (POS) machine, a customer premises equipment (CPE), a wireless terminal in industrial control, a smart home device (for example, a refrigerator, a television, an air conditioner, or an electric meter), a smart robot, a robot arm, a workshop device, a wireless terminal in unmanned driving, a wireless terminal in telemedicine, a wireless terminal in a smart grid, a wireless terminal in transportation safety, a wireless terminal in a smart city, a wireless terminal in a smart home, a flight device (for example, a smart robot, a hot air balloon, an uncrewed aerial vehicle, or an airplane), or the like. The terminal device may alternatively be another device having a terminal function. For example, the terminal device may alternatively be a device functioning as a terminal function in D2D communication. In this application, a terminal device having a wireless transceiver function and a chip that can be disposed in the terminal device are collectively referred to as the terminal device. A device form of the terminal is not limited in embodiments of this application.

In the 5G era, with the large-scale commercial use of active antenna units (AAUs), the quantity of antennas on an access network device side significantly increases. Compared with that in the 3G and 4G eras, energy consumption of an access network device increases exponentially. In addition, in a 5G communication system and an evolved communication system after 5G, for example, 6G, a higher data rate and higher traffic need to be supported. Therefore, the transmission bandwidth is larger, and correspondingly, the energy consumption of the access network device increases. Further, with the use of millimeter waves and terahertz, the quantity of access network device sites needs to be increased to implement a denser deployment manner, and an increase in the quantity of sites means an increase in overall network energy consumption.

To reduce the network energy consumption, an NR system supports a shutdown technology for access network devices and an activation and deactivation technology for cells. In other words, when there is no user, a base station is shut down, or a cell is deactivated. Therefore, the operation of an access network device or a cell that is not accessed by any user is stopped, to implement energy saving. However, such reduction can adjust energy consumption only between the highest energy consumption and the lowest energy consumption (or no energy consumption), and correspondingly, communication performance of the device can be switched only between the highest communication performance and no communication. Therefore, only when there is no user for a long time, the cell is deactivated, or the base station is shut down, and in other times, the access network device or the cell still needs to operate in a high performance mode. As a result, the energy saving cannot be maximized.

An embodiment of this application provides a communication method. The method is implemented by a network device that supports a plurality of operation modes, and a terminal apparatus. The network device has different energy consumption in the plurality of operation modes. In different network conditions, communication is performed between the terminal apparatus and the network device by using appropriate operation modes, so that the network energy consumption can be reduced, and a requirement of communication between the terminal apparatus and the network device can be met.

Specifically, the communication method provided in some embodiments of this application may be implemented by the terminal apparatus and a network apparatus. The terminal apparatus may be a terminal device or a component in a terminal device. The network apparatus may be the network device or a component in the network device. In this application, the component may be at least one of a chip, a chip system, a processor, a transceiver, a processing unit, or a transceiver unit in the device. The terminal device may be the terminal 102 shown in FIG. 1. The network device may be the network device 101 shown in FIG. 1, may be a component in the network device, or may be a structure or node such as an AAU, a DU, or a CU.

The following describes a procedure of the communication method provided in this embodiment of this application by using the network device and the terminal apparatus as execution bodies. As shown in FIG. 2, the method may include the following steps.

S101: The terminal apparatus obtains operation mode information of the network device.

An operation mode of the network device includes one of a first operation mode or a second operation mode. The first operation mode and the second operation mode belong to a same radio access technology (RAT). The same radio access technology is, for example, a radio access technology in a 5G communication system or a radio access technology in a 6G communication system. Therefore, in some embodiments, the switching is between different operation modes in the same radio access technology.

In this application, energy consumption of the network device in the first operation mode is lower than energy consumption of the network device in the second operation mode, and/or communication performance of the network device in the second operation mode is better than performance of the network device in the first operation mode. The communication performance may be, for example, a supported maximum rate or a supported minimum delay. For example, a maximum rate of the network device in the second operation mode is higher than a maximum rate of the network device in the first operation mode. For another example, a minimum delay of the network device in the second operation mode is lower than a minimum delay of the network device in the first operation mode. In this application, the first operation mode may also be referred to as an energy saving (ES) mode, and the second operation mode may be referred to as an enhanced communication (ET) mode. It may be understood that the network device operates in one of the first operation mode and the second operation mode at each moment, and when the operation mode of the network device is switched between the first operation mode and the second operation mode, a RAT change is not required.

A difference between the energy consumption in the first operation mode and the energy consumption in the second operation mode is caused by a difference in the first operation mode and the second operation mode that includes at least one of a time-frequency resource configuration for a channel/signal of the network device, a space domain resource configuration, a transmit power configuration, a hardware parameter configuration, or a function configuration enabled by the network device.

Specifically, the first operation mode and the second operation mode may have at least one of the following differences.

(1) A signal class of common information sent by the network device in the first operation mode is different from a signal class of common information sent by the network device in the second operation mode. A resource occupied by the common information sent by the network device in the first operation mode is different from that of the common information sent by the network device in the second operation mode. The common information may include a common channel and/or a common signal.

The common signal may include one or more of the following types: a primary synchronization signal (PSS), a secondary synchronization signal (SSS), a channel state information reference signal (CSI-RS) system message, or a paging message. The common channel may include one or more of the following types: a physical broadcast channel (PBCH), a physical random access channel (PRACH), or a physical downlink control channel (PDCCH). That the signal classes of common channels and/or common signals are different may be understood as that the network device separately uses different types of common channels and/or common signals in the first operation mode and the second operation mode, for example, using sequences of different types and/or lengths to send channels and/or signals.

Optionally, the configurations of a synchronization signal and PBCH block (SSB) of the network device in the first operation mode and the second operation mode are different. The SSB may include a PSS, an SSS, and a master information block (MIB). The MIB may be carried on a PBCH. The configuration of the SSB includes at least one of a signal included in the SSB, a quantity of time domain symbols for the SSB, a quantity of frequency domain resource blocks (RBs) for the SSB, a cycle of the SSB, a sequence type, or a sequence length. Therefore, at least one of the following: the signal included in the SSB of the network device, the quantity of time domain symbols for the SSB, the quantity of frequency domain RBs for the SSB, the cycle of the SSB, the sequence type, or the sequence length, is different in the first operation mode and the second operation mode.

In a possible implementation, overheads of a transmission resource for the common information of the network device in the first operation mode are lower than overheads of a transmission resource for the common information of the network device in the second operation mode.

The overheads of the transmission resource may be measured by using a size of the transmission resource. For example, in a same time range (for example, one or more slots), the size of a time-frequency resource for a synchronization signal of the network device in the first operation mode is less than the size of a time-frequency resource for a synchronization signal of the network device in the second operation mode. For example, a downlink synchronization access signal sent by the network device in the first operation mode includes a primary synchronization signal, occupies one symbol in time domain, has a sequence length of 62, and occupies six RBs in frequency domain. A downlink synchronization access signal sent by the network device in the second operation mode includes a primary synchronization signal, a secondary synchronization signal, and a physical broadcast channel (that is, the downlink synchronization access signal corresponds to the foregoing SSB), occupies a plurality of symbols (for example, four symbols) in time domain, and occupies more than six RBs (for example, occupies 12 RBs) in frequency domain, where the sequence lengths of the synchronization signals (that is, the primary synchronization signal and the secondary synchronization signal) are 127.

In addition, it may be understood that the overheads of the transmission resource may be overheads of a time domain resource and/or a frequency domain resource. In other words, overheads of a time domain resource for the common information of the network device in the first operation mode are lower than overheads of a time domain resource for the common information of the network device in the second operation mode, and/or overheads of a frequency domain resource for the common information of the network device in the first operation mode are lower than overheads of a frequency domain resource for the common information of the network device in the second operation mode. For example, the quantity of time domain symbols for the downlink synchronization access signal of the network device in the first operation mode may be less than the quantity of time domain symbols for the downlink synchronization access signal of the network device in the second operation mode, and/or the quantity of frequency domain RBs for the downlink synchronization access signal of the network device in the first operation mode may be less than the quantity of frequency domain RBs for the downlink synchronization access signal of the network device in the second operation mode. The downlink synchronization access signal may be a primary synchronization signal, a secondary synchronization signal, or an SSB.

In a possible implementation, when the signal classes of the common information are different, the terminal apparatus may identify a current operation mode of the network device based on the signal class of common information sent by the network device. The terminal apparatus may learn, based on a configuration of the signal classes of the common information of the network device, the signal classes of common information of the network device in different operation modes. Therefore, after receiving the common information from the network device, the terminal apparatus may determine a corresponding operation mode as the current operation mode of the network device based on the signal class of the received common information.

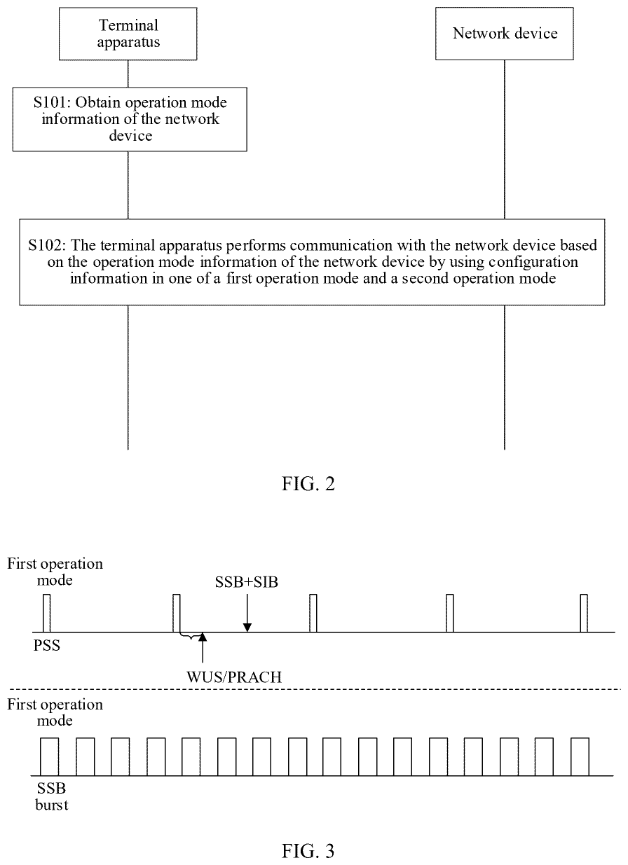

FIG. 3 illustrates an example. The synchronization signal sent by the network device in the first operation mode is a PSS whose sequence length is 62, and the downlink synchronization access signal sent in the second operation mode is one or more SSBs. A plurality of SSBs are also referred to as an SSB burst. Each SSB includes a PSS, an SSS, and a MIB, and the sequence lengths of the PSS and the SSS are both 127. Therefore, when determining that a received synchronization signal is a PSS whose sequence length is 62, the terminal apparatus determines that the current operation mode of the network device is the first operation mode; or when determining that a received synchronization signal is a primary synchronization signal whose sequence length is 127, or determining that one or more SSBs are received, the terminal apparatus determines that the current operation mode of the network device is the second operation mode.

Because the content and types of the downlink synchronization access signals are different, the access procedure of the network device in the first operation mode and the access procedure of the network device in the second operation mode are also different. This difference is described below.

In another possible implementation, the common information sent by the network device in the first operation mode still exists in the second operation mode, and the network device only needs to incrementally send, in the second operation mode, additional common information in the second operation mode.

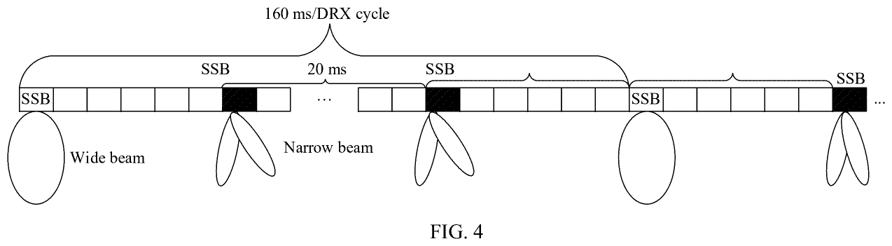

As shown in FIG. 4, the synchronization signal (an SSB is used as an example but not a limitation in the figure) sent by the network device in the first operation mode is a wide beam signal, while the synchronization signal sent by the network device in the second operation mode includes both the wide beam SSB signal and a narrow beam SSB signal. Therefore, when the network device is in the first operation mode, the network device sends the wide beam SSB signal. Correspondingly, the terminal apparatus may access the network device based on the wide beam SSB signal. When the network device enters the second operation mode, the network device may continue to send the wide beam SSB signal, and may additionally send the narrow beam SSB signal. Correspondingly, the terminal apparatus may access the network device based on the wide beam SSB signal or the narrow beam SSB signal.

In the first operation mode, the network device may send the wide beam SSB signal (or referred to as a long-cycle SSB signal) at a large interval, to reduce energy consumption. For example, a sending interval (which may be referred to as a long cycle) of the wide beam SSB signal is greater than a sending interval (which may be referred to as a short cycle) of the narrow beam SSB signal (or referred to as a short-cycle SSB signal) in the second operation mode. For example, the long cycle may be a fixed cycle, for example, 160 milliseconds (ms), or may be a discontinuous reception (DRX) cycle broadcast by a base station. The short cycle may be a fixed cycle, or a cycle configured by a network, for example, 20 ms. In the second operation mode, repeated sending of the SSB is supported, to ensure cell coverage and time-frequency synchronization performance in a low signal-to-noise ratio (SNR) area. To be specific, the network device continuously sends two or more of the same narrow beam SSB signals. A specific quantity of the narrow beam SSB signals may be preconfigured, predefined, or implicitly indicated by the network device by using the SSB. This is not specifically limited in this application. Beam directions of narrow beam SSB signals sent by the network device in different short cycles are different. Because the terminal apparatus may move around, the terminal apparatus may be at different locations at different moments. A narrow SSB beam in a short cycle can provide a better measurement signal for the terminal to improve measurement performance. When the terminal moves, a corresponding SSB beam may also be switched. Therefore, directions of SSB beams in different cycles are different.

Optionally, in a scenario shown in FIG. 4, there are two manners of sending the SSB in the network: a long-cycle wide beam sending manner and a short-cycle narrow beam sending manner. Each narrow beam SSB burst may include one or more SSBs.

In this application, a manner of calculating a quantity of paging occasions (POs) of the paging message is related to a type of an SSB beam (that is, a wide beam or a narrow beam), and the impact of a quantity of beams on the quantity of POs may be ignored. For example, the network device may send the paging message by using a same wide beam as a wide beam SSB. Even in the second operation mode, the network device does not send the paging message by using a same narrow beam as a narrow beam SSB through scanning. Similarly, the system information in this application may include remaining minimum system information (RMSI). In this application, the network device may also send the RMSI by using the same beam as the wide beam SSB by default. When the paging message and/or the RMSI are/is sent by using a wide beam, if there is only one wide beam, the RMSI is transmitted in only one slot in a cycle, and the paging message is transmitted in only one slot in the cycle. This reduces a transmission delay of the network device, and reduces energy consumption of the network device. If the paging message and/or the RMSI are/is sent by using a narrow beam, the network device repeatedly sends the paging message and/or the RMSI in different slots in a polling manner. As a result, the network device sends the paging message and/or the RMSI at a plurality of moments, correspondingly increasing energy consumption of the base station.

Optionally, the network device may indicate, by using the common information sent in the first operation mode, that the common information in the second operation mode is sent at a subsequent short-cycle candidate sending location for common information. If the network device does not indicate, by using the common information sent in the first operation mode, that the common information in the second operation mode is sent at the subsequent short-cycle candidate sending location for common information, the terminal apparatus may consider by default that the common information in the second operation mode is not sent at the subsequent short-cycle candidate sending location. That is, the operation mode of the network device is still the first operation mode. Therefore, the common information in the short-cycle candidate sending location does not need to be blindly detected. For example, the network device may carry specific indication information by using the common information sent in the first operation mode. When receiving the indication information, the terminal apparatus may detect the common information in the second operation mode in a short cycle after a time domain position indicated by the indication information. When not receiving the indication information, the terminal apparatus does not detect the common information in the second operation mode. Therefore, energy consumption of the terminal apparatus is reduced.

FIG. 4 is another example used to describe a possible implementation of the indication information. The wide beam SSB signal may carry explicit or implicit indication information indicating whether the narrow beam SSB signal is sent in a subsequent short cycle. For example, the network device may carry 1-bit indication information in the wide beam SSB, to explicitly indicate whether the narrow beam SSB signal exists in the subsequent short cycle. Alternatively, an SSB signal in a specific format or sequence may be predefined as a wide beam SSB signal, to indicate whether the narrow beam SSB signal is sent in the subsequent short cycle.

Based on the foregoing descriptions, because the signal classes of the common information of the network device and/or the resources occupied by the common information of the network device in the first operation mode and the second operation mode are different, when communicating with the network device, the terminal apparatus needs to obtain the signal class and/or occupied resource configuration for the common information of the network device in the current operation mode, and access the network device based on the configuration.

The following describes, with reference to Manner 1 and Manner 2, a manner in which the terminal apparatus obtains the signal class and/or occupied resource configuration for the common information.

Manner 1: After entering the current operation mode, the network device may send the first configuration information corresponding to the current operation mode. The first configuration information may include the signal class and/or occupied resource configuration for the common information in the current operation mode, and a common part configuration. Therefore, the terminal apparatus may learn, based on the first configuration information, the signal class and/or occupied resource configuration for the common information of the current network device in the current operation mode, and the common part configuration.

In this application, the common part configuration means that when the network device sends configuration information to the terminal apparatus, other than the configuration information for the common information, some configurations are common for some UE-specific channels (such as a PDSCH and a physical uplink control channel (PUCCH)). That is, these configurations are effective in different operation modes. In this case, the configuration information may be sent by using a broadcast message, and these configurations may be referred to as common part configurations. For example, the common part configuration may include configuration information of a CORESET 0, configuration information of a search space 0, or a PDSCH time domain allocation list that is broadcast in system information.

Optionally, the first configuration information may be sent in a broadcast or multicast manner. If sent in the broadcast manner, the first configuration information may be carried in a broadcast message, for example, a SIB message; or if sent in the multicast manner, the first configuration information may be carried in a PDSCH scheduled by using group downlink control information (DCI). In addition, the first configuration information may alternatively be carried in a radio resource control (RRC) message, a media access control (MAC) control element (CE), or DCI, so that the network device may send configuration information in an operation mode to a UE in a point-to-point manner.

Manner 2: The network device sends the second configuration information to the terminal apparatus. The second configuration information includes configuration information corresponding to the first operation mode and configuration information corresponding to the second operation mode. The second configuration information may be sent by the network device to the terminal apparatus after the terminal apparatus accesses the network device. Therefore, the network device does not need to send, each time when entering a new operation mode, applicable configuration information for common information in the current operation mode, which can reduce signaling overheads. After the operation mode is switched, the network device may send the operation mode information. Refer to the foregoing descriptions. The operation mode information may include first information or second information. The first information may indicate the current operation mode. The second information may indicate that the operation mode is switched. The terminal apparatus may determine, based on the second configuration information and the operation mode information, the applicable configuration information in the current operation mode of the network device.

Optionally, the second configuration information may include a signal class and/or occupied resource configuration for the common information in the first operation mode, a signal class and/or occupied resource configuration for the common information in the second operation mode, and a common part configuration.

Optionally, the second configuration information may be sent in a broadcast or multicast manner. If sent in the broadcast manner, the second configuration information may be carried in a broadcast message; or if sent in the multicast manner, the second configuration information may be carried in group DCI, a paging message, a SIB message, or the like. In addition, the second configuration information may alternatively be carried in an RRC message, a MAC CE, or DCI, so that the network device may send the second configuration information to a UE in a point-to-point manner.

(2) A space domain resource configuration of the network device in the first operation mode is different from a space domain resource configuration of the network device in the second operation mode.

For example, compared with those in the second operation mode, the overheads of a space domain related resource used by the network device in the first operation mode are lower. The space domain resource may include at least one of an antenna resource (including a TRP and an antenna port), a CSI-RS measurement resource, a CSI-RS feedback resource, or a TRP-associated control resource set (CORESET).

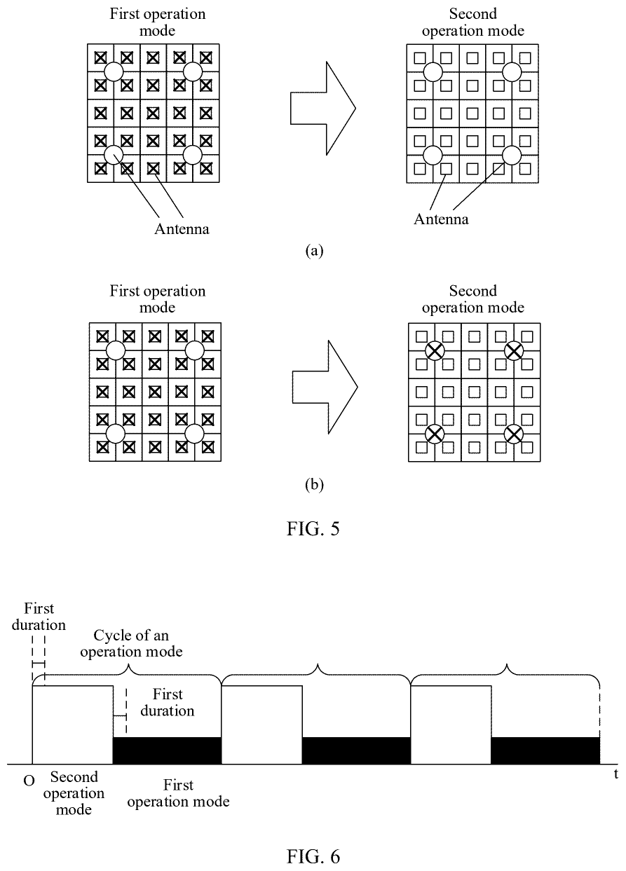

In an implementation, the network device enables a small quantity of antennas in the first operation mode, and the network device enables more antennas in the second operation mode. As shown in an example (a) in FIG. 5, antennas enabled by the network device in the first operation mode are some antennas among all antennas of the network device, and are antennas shown by circles in the figure. In FIG. 5, “x” indicates an antenna that is not enabled. The antennas associated with the network device in the second operation mode are all the antennas of the network device, for example, 32 antennas. The antennas shown in FIG. 5 are merely an example, and do not represent an actual antenna layout or an actual antenna quantity. As shown in an example (b) in FIG. 5, the antennas associated with the network device in the second operation mode are some antennas of the network device, and the quantity of antennas enabled by the network device in the second operation mode is greater than the quantity of antennas enabled by the network device in the first operation mode. For example, the network device enables the antennas shown by circles in the first operation mode, and the network device enables antennas other than the antennas shown by the circles in the second operation mode. It can be learned that in the example (b) in FIG. 5, the antennas enabled by the network device in the first operation mode are not the same as the antennas enabled in the second operation mode. In other words, the switching of the operation mode of the network device is accompanied by switching of the operation statuses of all the antennas. In addition, there may alternatively be at least one antenna enabled by the network device in both the first operation mode and the second operation mode. For an implementation of this case, refer to FIG. 5. This is not specifically required in this application.

Optionally, when the network device enables different antennas in different operation modes, the network device may further select, in different operation modes, hardware associated with the antennas. For example, the hardware may include an analog to digital converter (ADC), a digital-to-analog converter (DAC), or a power amplifier (PA).

For example, in FIG. 5, the type of an antenna shown by a circle may be different from the type of an antenna shown by a square. That the types of the antennas are different means that the antennas are associated with different hardware. For example, when the network device activates the antenna shown by a circle, the antenna is associated with hardware having a low power consumption characteristic, for example, an ADC, a DAC, and a PA. When the network device activates the antenna shown by a square, the antenna is associated with hardware having a high power consumption characteristic, for example, an ADC, a DAC, and a PA.

In a possible implementation, the antenna enabled by the network device in the first operation mode is a first-type antenna, and correspondingly, an ADC module and a DAC module associated with the first-type antenna use fewer quantization bits for sampling. The antenna enabled by the network device in the second operation mode is a second-type antenna, and correspondingly, an ADC module and a DAC module associated with the second-type antenna use more quantization bits for sampling. In other words, the quantity of quantization bits used by the ADC module and the DAC module associated with the first-type antenna is less than the quantity of quantization bits used by the ADC module and the DAC module associated with the second-type antenna. A larger quantity of bits indicates higher conversion accuracy of the ADC module and the DAC module and higher energy consumption by the modules.

In another possible implementation, the antenna enabled by the network device in the first operation mode is a first-type antenna, and the antenna enabled by the network device in the second operation mode is a second-type antenna. Correspondingly, power consumption of a PA of the network device in the first operation mode is less than power consumption of a PA of the network device in the second operation mode. In other words, power consumption of a PA associated with the first-type antenna is less than power consumption of a PA associated with the second-type antenna.

To support fast switching between different operation modes, the network device separately configures a CSI-RS measurement resource, a CSI-RS feedback resource, and/or a TRP-associated control resource set in the first operation mode, and a CSI-RS measurement resource, a CSI-RS feedback resource, and/or a TRP-associated control resource set in the second operation mode. The CSI-RS measurement resource, the CSI-RS feedback resource, and/or the TRP-associated control resource set in the first operation mode are/is less than the CSI-RS measurement resource, the CSI-RS feedback resource, and/or the TRP-associated control resource set in the second operation mode.

(3) The functions supported by the network device in the first operation mode is a proper subset of the functions supported by the network device in the second operation mode.

In this application, the functions of the network device in the first operation mode or the second operation mode may include at least one of functions such as a dual active protocol stack (DAPS), conditional handover (CHO), two-step random access (2 step RA), small data transmission (SDT), a reduced capability (RedCap), vehicle-to-everything, a multicast broadcast service (MBS), slicing, an industrial internet of things (IIoT), extended reality (XR), uplink data compression (UDC), positioning, paging, ultra-reliable low-latency communication (URLLC), high-order modulation, grant-free scheduling, sensing, artificial intelligence (AI), unlicensed spectrum transmission, multi-layer transmission, or non-slot scheduling.

The DAPS function means that the terminal apparatus still keeps a resource connection to a source gNB after receiving an RRC message including a handover command, and when successfully completing random access on a target gNB, the terminal apparatus releases the source cell. Therefore, before handover of the terminal apparatus is completed, the source cell keeps a connection to the terminal apparatus.

The CHO function means that the terminal apparatus performs handover when one or more handover conditions are satisfied. Therefore, the terminal apparatus evaluates a handover condition after receiving a CHO configuration, and the terminal apparatus initiates handover when the handover condition is satisfied. Therefore, a network device in a CHO list needs to periodically send a measurement signal for measurement by the terminal.

The two-step random access function is a simplified random access process, and can achieve low control overheads and a low delay. A message A (MSG A) sent by the terminal apparatus in a two-step random access process includes a preamble signal and data, where the data may be sent in a grant-free (GF) manner in a preconfigured resource. In addition, a message B (MSG B) sent by the terminal device in the two-step random access process is a random access response (RA response) message. In this scenario, a network side blindly detects both the preamble signal and the data in a first-step access process.

The small data transmission function supports the terminal apparatus in performing small data packet transmission in an RRC inactive state, so that power consumption on the terminal side can be reduced to the maximum extent. Small data may be sent together with a third message (Msg3) or a message A in a random access process, or may be sent by using a preconfigured granted scheduling (CG) resource. Therefore, the network device needs to correspondingly perform data packet detection.

The grant-free transmission function requires the network device to preconfigure, for the terminal apparatus in a semi-static manner, a physical uplink shared channel (PUSCH) resource and a transmission parameter that are for uplink data transmission. When sending small data, the terminal apparatus sends the data to the network device by using the preconfigured PUSCH resource and transmission parameter, without a need to receive a dynamic uplink grant from the network device and send a preamble to perform random access. Correspondingly, the network device needs to detect, on a configured grant-free scheduling resource, whether the terminal apparatus sends data.

The RedCap function supports a low-complexity 5G terminal apparatus. The terminal apparatus is between enhanced mobile broadband (eMBB) and massive internet of things communication (mMTC) in terms of bandwidth, power consumption, antenna design, and costs, and can effectively balance capabilities between large broadband, a high rate, a wide connection, and a low delay in a 5G technology, to meet differentiated industry networking requirements. The network device needs to provide corresponding configuration information and communicate with a RedCap terminal.

The vehicle-to-everything function is mainly used to support communication between vehicles, between a vehicle and an access network device, and between access network devices, to transmit traffic information such as a real-time road condition and road information. The first operation mode (Mode 1) for network scheduling is supported in vehicle-to-everything. The network device needs to interact with the terminal apparatus in the first operation mode. In addition, for the second operation mode (Mode 2) supported in vehicle-to-everything, the network device needs to broadcast vehicle-to-everything related configuration information by using a broadcast message.

For the multicast broadcast service function, the network device needs to support establishment of an MBS session. An MBS session can be classified as a multicast MBS session or a broadcast MBS session, which supports a multicast MBS or a broadcast MBS respectively. In the multicast broadcast service, the network side may implement data transmission for a specific plurality of terminal apparatus members (a multicast MBS) or a non-specific quantity of terminal apparatus members (a broadcast MBS) by using the MBS session. An access network device receives, by using the MBS session, service data sent for the plurality of terminal apparatus members. Then, the access network device performs data distribution. Therefore, it is not required to separately establish a data session for each terminal apparatus member, which can reduce overheads in a data transmission process. For the broadcast MBS session, the network device cannot detect the quantity of users, and will keep sending MBS data after the session starts, increasing energy consumption. It may be understood that when the first operation mode does not support the multicast broadcast service function, information sent by the network device in the first operation mode may be sent in a point-to-point manner.

The slicing function requires the network device to support a network slicing technology. A network slicing technology may divide a physical network into a plurality of virtual end-to-end networks. The virtual networks (including devices, access networks, transmission networks, and core networks in the networks) are logically independent of each other, and can support different communication requirements. A fault in any virtual network does not affect another virtual network.

The industrial internet of things (IoT) function supports management operations of an access network device such as analysis, control, and monitoring on an IoT device in the IoT scenario. To support the industrial IoT function, the network device needs to correspondingly enable functions such as grant-free scheduling, non-slot scheduling, or a partial bandwidth with a large subcarrier spacing, and configure an independent scheduling request, a transmission channel, or the like, to reduce a signal transmission delay and improve transmission reliability.

The sensing function requires an access network device to support detection and/or collection of sensing data based on a configuration or an indication of a sensing function (SF) network element. In addition, the sensing function requires the access network device to support reporting of the sensing data to the sensing function network element.

For the AI function, AI is generally a technology that exhibits human intelligence via a computer program. An AI model is an algorithm or a computer program that can implement the AI function. The AI model represents a mapping relationship between an input and an output of the model. The AI model may be a neural network or another machine learning model. In this application, the AI function may require an access network device to support training and inference of the AI model, or may require an access network device to cooperate with the terminal apparatus to perform training, inference, and the like of the AI model.

Unlicensed spectrum transmission is air interface transmission on an unlicensed frequency band. In other words, data may be sent and received on a spectrum that can be used without being authorized by a competent authority when a regulatory rule condition is satisfied.

The XR function requires a network device to support XR-related functions such as sensing and data analysis, to support an XR service. The network device provides corresponding configuration information supporting the XR function and communicate with the terminal apparatus.

The uplink data compression function means that the terminal apparatus performs intelligent compression on the data at a bottom layer during uplink data transmission based on a scenario and application data. Correspondingly, when receiving the compressed data, the network device needs to decompress the compressed data to restore the data. On the one hand, UDC can effectively reduce uplink air interface data traffic and improve uplink air interface utilization efficiency. On the other hand, UDC can reduce related interference with another terminal and improve reliability of uplink data transmission. The network device needs to provide a UDC-related configuration and retain dictionary information used during data compression/decompression.

The positioning function requires the network device to measure a location of the terminal device based on the positioning information from a core network. The network device needs to provide a positioning-related configuration for the terminal apparatus in a broadcast or unicast manner. For uplink positioning, the network device further supports estimation of the location of the terminal apparatus by receiving a signal from the terminal apparatus.

The paging function requires the network device to support sending of a paging occasion in a paging frame (PF). The paging message may be monitored and received by the terminal apparatus in an RRC idle state or an RRC inactive state. The paging message may include an identifier of the terminal apparatus, indicating that the paging message is used to search for the terminal apparatus. The network device needs to broadcast a paging-related configuration, and when the paging message arrives, send, in a broadcast manner in a plurality of sites in a paging area in which the terminal apparatus resides, the paging message at a paging sending location determined based on the paging-related configuration.

The ultra-reliable low-latency communication function requires the network device to support a service that is highly sensitive to latency and stability. The ultra-reliable low-latency communication function may be ensured by using functions such as a network slicing technology, grant-free scheduling, non-slot scheduling, lower-order modulation, or lower-code-rate channel coding.

High-order modulation is generally modulation of a fourth order or above. For example, the network device may include a high-order modulation function in the second operation mode, and does not include the high-order modulation function in the first operation mode, that is, supports only modulation below the fourth order. Alternatively, a maximum modulation order supported by the network device in the second operation mode is greater than a maximum modulation order supported in the first operation mode.

Non-slot scheduling is also referred to as mini-slot scheduling or non-slot transmission. To reduce a transmission delay, when scheduling the terminal apparatus, the network device uses a smaller time domain scheduling granularity, to reduce the transmission delay. Correspondingly, the network device requires a shorter processing delay, causing an increase in energy consumption by the network device.

The multi-layer transmission function requires the network device to divide the data to be sent into a plurality of data streams (that is, each data stream is a layer) when sending the data, code and modulate the data streams by using different antennas, and then transmit the data streams, to improve the transmission rate of the system. In addition, when receiving data, the network device further needs to separate a received signal, demodulate and decode a plurality of data streams, and then combine the plurality of data streams to restore an original signal. Different data streams may correspond to different terminal apparatuses. Multi-layer transmission can improve spectral efficiency. In some embodiments of the present application, the network device does not support multi-layer transmission in the first operation mode, and the network device supports multi-layer transmission in the second operation mode. Alternatively, a maximum quantity of layers of multi-layer transmission supported by the network device in the first operation mode is less than a maximum quantity of layers of multi-layer transmission supported by the network device in the second operation mode.

The network device may support all of the foregoing functions in the second operation mode, and the network device supports only some functions in the first operation mode. Alternatively, the network device may support some of the foregoing functions in the second operation mode, and the network device supports, in the first operation mode, only some of the functions supported by the network device in the second operation mode. Alternatively, for high-order modulation (or multi-layer transmission), the maximum modulation order (or the maximum quantity of transmission layers) supported by the network device in the second operation mode is greater than the maximum modulation order (or the maximum quantity of transmission layers) supported by the network device in the first operation mode. Therefore, the network device supports more functions in the second operation mode than in the first operation mode, which can improve the communication performance.

It may be understood that the terminal apparatus may learn, based on configuration information in the operation mode of the network device, a function supported and/or not supported by the network device in the current operation mode.

Refer to the foregoing Manner 1. In this application, the network device may send the third configuration information after entering the current operation mode. The third configuration information may indicate a function supported and/or a function not supported by the network device in the current operation mode, and/or a related configuration of a function supported by the network device.

The third configuration information may be carried in a same message or information as the first configuration information in Manner 1, or may be sent separately from the first configuration information. Optionally, refer to the descriptions of Manner 1. The third configuration information may be sent in a broadcast manner, may be sent in a multicast manner, or may be sent in a point-to-point manner.

In addition, refer to the foregoing Manner 2. The network device may alternatively send the fourth configuration information. The fourth configuration information may indicate the function supported by the network device in the first operation mode and/or a related configuration of the function supported by the network device. In addition, the fourth configuration information may further indicate the function supported by the network device in the second operation mode, and/or a related configuration of the function supported by the network device. The fourth information may be sent by the network device to the terminal apparatus after the terminal apparatus accesses the network device. Therefore, the network device does not need to send, each time when entering a new operation mode, the applicable configuration information of a function in the current operation mode, which can reduce the signaling overheads. After the operation mode is switched, the network device may send the operation mode information, so that the terminal apparatus may determine, based on the fourth configuration information and the operation mode information, the applicable configuration information of the function in the current operation mode of the network device.

The fourth configuration information may be carried in a same message or information as the second configuration information in Manner 2, or may be sent separately from the second configuration information. Optionally, refer to the descriptions of Manner 2. The fourth configuration information may be sent in the broadcast manner, may be sent in the multicast manner, or may be sent in the point-to-point manner.

In a possible implementation, if the network device does not support a function in the current operation mode, the terminal apparatus may delete the function from a function list, to avoid a communication failure caused by use of the function that the network device does not have by the terminal apparatus for communication. Optionally, the terminal apparatus may update the function list after learning that the operation mode of the network device is switched. For example, when the uplink data compression function is not supported in the first operation mode of the network device, the terminal apparatus may delete the uplink data compression function from the function list after the network device switches to the first operation mode, that is, the terminal apparatus does not perform uplink data compression when communicating with the network device in the first operation mode.

In another possible implementation, if the network device does not support a function in the first operation mode but supports the function in the second operation mode, the terminal apparatus may implicitly indicate, by transmitting a message, data, or a signal corresponding to the function, to the network device to switch to the second operation mode, or the network device may switch to the second operation mode or enable the corresponding function when the network device needs to perform the function supported in the second operation mode but not supported in the first operation mode. For example, the network device supports only the paging function when in the first operation mode. In this case, when there is non-paging communication information, message, or data that needs to be sent, the network device needs to switch to the second operation mode. For another example, when in the first operation mode, the network device supports only a quantity of transmission layers that is not greater than a threshold. In this case, when there is a transmission requirement for a quantity of transmission layers that is greater than the threshold, the network device may switch to the second operation mode.

In addition, the network device may further indicate the current operation mode and/or the function supported in the operation mode to a neighboring-station network device. In a possible example, when a first network device is in the first operation mode, the first network device may send a notification to a neighboring-station network device (for example, a second network device), to notify an operation mode of the first network device. Correspondingly, when configuring a CHO list for a terminal, the second network device does not add the first network device to the CHO list, that is, does not use the first network device as a target base station of CHO. In addition, after learning this information, the terminal apparatus may also delete the first network device from the CHO list.

(4) The access procedure in the first operation mode is different from the access procedure in the second operation mode.

Optionally, the network device may send different synchronization signals in the first operation mode and the second operation mode. For example, the network device sends a first synchronization signal and a second synchronization signal in the first operation mode and the second operation mode respectively. The sequence type of the first synchronization signal is different from the sequence type of the second synchronization signal. For example, the sequence type may include an m-sequence and a Zadoff-Chu (ZC) sequence. The first synchronization signal and the second synchronization signal may use different sequence types. For example, the first synchronization sequence uses a ZC sequence, and the second synchronization sequence uses an m-sequence or another type of sequence. In addition, the sequence length of the first synchronization signal may be different from the sequence length of the second synchronization signal. For example, the sequence length of the first synchronization signal may be less than the sequence length of the second synchronization signal, to reduce energy consumption of the network device in the first operation mode. In addition, a time domain resource for the first synchronization signal is different from a time domain resource for the second synchronization signal, and/or a frequency domain resource for the first synchronization signal is different from a frequency domain resource for the second synchronization signal.

The following separately describes possible access procedures in the first operation mode and the second operation mode.

When operating in the first operation mode, the network device may send the first synchronization signal. Correspondingly, the terminal apparatus may perform synchronization based on the first synchronization signal, and send a random access request after completing synchronization, to initiate random access. Optionally, if the first synchronization signal does not include a MIB, the terminal apparatus may further send a first message to the network device after completing synchronization, to request the network device to send the MIB (for example, included in the SSB) and system information (for example, a SIB message). The first message may be a wake-up signal (WUS), a PRACH signal, or another uplink signal. The MIB may include an access configuration (for example, including information such as a system frame number, whether access to a cell is forbidden, or a downlink control channel configuration). The system information may include a random access resource configuration (for example, including information used to evaluate whether the terminal is allowed to access the cell, and a common radio resource configuration). Therefore, the terminal apparatus may initiate random access based on the access configuration and the random access resource configuration.

For example, as shown in FIG. 3, the first synchronization signal may be a PSS, for example, a PSS whose sequence length is 62. In the first operation mode, the terminal apparatus may receive the PSS to perform downlink synchronization. After completing synchronization, the terminal apparatus may send a WUS signal or a PRACH signal to the network device in a manner (for example, a sending occasion or a frequency domain sending location) predefined in a protocol. Correspondingly, after receiving the WUS or the PRACH signal from the terminal apparatus, the network device sends an SSB and a corresponding SIB message. The SSB may include an access configuration such as a cell ID and a frame number. The SIB message may include random access (RACH) resource configuration information (that is, obtain a random access resource configuration). Therefore, the terminal apparatus may send a random access preamble on a corresponding RACH resource, to initiate initial access.

In addition, the network device may send the second synchronization signal, a master information block, and system information in the second operation mode. Correspondingly, the terminal apparatus performs downlink synchronization based on the received second synchronization signal, and initiates random access based on an access configuration included in the master information block and a random access resource configuration included in the system information.

As shown in FIG. 3, the second synchronization signal may be one or more SSBs (the SSB burst is used as an example in FIG. 3), and the terminal apparatus may perform downlink synchronization based on the SSB burst. For example, the SSB may include a primary synchronization signal and a secondary synchronization signal whose sequence lengths are both 127. In addition, the SSB burst may further include an access configuration such as a cell ID and a frame number, and the configuration information of a SIB 1. The terminal apparatus may receive the SIB 1 based on the configuration information of the SIB 1, where the SIB 1 may include RACH resource configuration information. The terminal apparatus may send a random access preamble based on the access configuration included in the SSB and the RACH resource configuration information included in the SIB 1, to initiate initial access.

It can be learned that in the example in FIG. 3, in the first operation mode, the network device sends the SSB and the SIB only after receiving the first message (that is, the WUS or the PRACH signal in FIG. 3). In the second operation mode, the network device sends the SSB burst, that is, the master information block and the configuration information of the SIB 1 are included. Therefore, the power consumption of the network device in the first operation mode can be reduced.

(5) The quantity of paging occasions in the first operation mode is the same as the quantity of paging occasions in the second operation mode.

Optionally, the quantity of paging occasions is related to the beam types of synchronization signals of the network device in different operation modes. The quantity of paging occasions of the network device in the first operation mode may be the same as the quantity of paging occasions in the second operation mode. In the second operation mode, transmission performance may be improved by increasing a quantity of synchronization signals, but the quantity of paging messages does not need to be increased. Therefore, paging energy consumption in the second operation mode can be reduced.

FIG. 3 is used as an example. In the first operation mode, a quantity of SSB beams sent by the network device in a long cycle is 1, and one paging occasion corresponds to one slot. When the quantity of SSB beams is increased, that is, in the second operation mode, the network device sends both a wide beam SSB and a narrow beam SSB burst, where the narrow beam SSB burst may include a plurality of SSBs. However, in this case, each paging occasion includes one slot. In other words, regardless of whether the network device is in the first operation mode or the second operation mode, the quantity of PDCCH detection slots included in each paging occasion is related only to the quantity of wide beam SSBs. In other words, adding narrow beam SSBs improves data transmission performance, but does not add paging occasions, that is, does not increase paging energy consumption.

(6) A manner of receiving RMSI of the network device in the first operation mode is different from a manner of receiving RMSI of the network device in the first operation mode.

Optionally, the RMSI is related to beam types of synchronization signals of the network device in different operation modes. Therefore, RMSI overheads of the network device in the first operation mode may be less than paging occasions of the network device in the second operation mode, to reduce the RMSI overheads in the first operation mode.

(7) A hardware parameter of the network device in the first operation mode is different from a hardware parameter of the network device in the second operation mode.

The network device may perform communication in the first operation mode and the second operation mode by using hardware having different hardware parameters. As described above, the hardware may include a PA, an ADC, a DAC, or the like. Optionally, the hardware selected by the network device may be related to a type of an antenna enabled by the network device in the operation mode. For details, refer to the foregoing descriptions of the antenna type. Details are not described again.

In addition, because the network device may use different hardware in the first operation mode and the second operation mode, the network device may use different modulation and coding scheme (MCS) tables, channel quality information (CQI) tables, or waveforms in different operation modes, to implement hardware adaptation.

In a possible implementation, a maximum order supported by an MCS table associated with the network device in the first operation mode is less than a maximum order supported by an MCS table associated with the network device in the second operation mode, and/or a maximum channel coding code rate supported by an MCS table associated with the network device in the first operation mode is less than a maximum channel coding code rate supported by an MCS table associated with the network device in the second operation mode. Correspondingly, the network device may use lower transmit power in the first operation mode, and reduce an MCS order or a channel coding code rate to avoid a decrease in signal coverage caused by a decrease in transmit power. Similarly, an order of a CQI table associated with the network device in the first operation mode is lower than an order of a CQI table associated with the network device in the second operation mode.

In another possible implementation, the ADC module and the DAC module associated with the network device in the first operation mode use fewer quantization bits for sampling, and the ADC module and the DAC module associated with the network device in the second operation mode use more quantization bits for sampling. A larger quantity of bits indicates higher conversion accuracy of the ADC module and the DAC module and higher energy consumption of the modules.

In another possible implementation, the power consumption of the PA associated with the network device in the first operation mode is less than the power consumption of the PA associated with the network device in the second operation mode.

In addition, compared with that used in the second operation mode, a waveform used by the network device in the first operation mode may also be a waveform with lower power consumption.

The following describes a manner in which the terminal apparatus obtains the operation mode information.

The operation mode information may be information (which may be referred to as the first information) indicating one of the first operation mode and the second operation mode. Alternatively, the operation mode information may be information (which may be referred to as the second information) used to determine switching status of the operation mode of the network device, for example, an operation mode switching indication.

The following describes the manner in which the terminal apparatus obtains the operation mode information.

(1) In a possible implementation, the operation mode information may be sent from the network device.

For example, when the network device enters an operation mode, the network device may send operation mode information by using group DCI, a paging message, or a system information block (SIB) message, or in other words, the operation mode information may be included in the group DCI, the paging message, or the SIB message. The terminal apparatus may obtain the operation mode information based on the received group DCI, paging message, or SIB message.

The group DCI may be DCI sent by the network device to one or more terminal apparatuses that access the network device. The group DCI may be scrambled by using a newly defined radio network temporary identifier (for example, a network energy saving RNTI (NES-RNTI)). The RNTI may be predefined in a protocol, or may be sent by the network device to the terminal apparatus that accesses the network device. When the operation mode information is sent by using the group DCI, a field used to carry the operation mode information may be defined in the group DCI. The field may directly indicate the operation mode. For example, a value 0 indicates the first operation mode, and a value 1 indicates the second operation mode. In this case, information carried in the field is the first information. Alternatively, the field may carry information related to operation mode switching, that is, carry the second information. For example, when the first operation mode is currently used, if the field in the group DCI is 0, it indicates that the operation mode of the network device remains unchanged; and if the value of the field in the group DCI is 1, it indicates that the operation mode of the network device is switched to the second operation mode. For another example, the first operation mode is currently used. If the value of the field in currently received DCI is the same as the value of the field in previously received DCI, it indicates that the operation mode of the network device remains unchanged; or if the value of the field in currently received DCI is different from the value of the field in previously received DCI, it indicates that the operation mode of the network device changes, and the information carried in the field is the second information.

The paging message may be directly carried in DCI scrambled by using a paging RNTI (p-RNTI), or may be carried in a message carried on a physical downlink shared channel (PDSCH) indicated by DCI. For a manner of indicating the operation mode of the network, the field used to carry the operation mode information may be defined in the paging message, or the field used to carry the operation mode information may be defined in a short message field of the paging message.

For example, as shown in Table 1, the field may be carried in a bit 5 in a short message. In Table 1, the field may indicate switching status of the operation mode of the network device. For example, a value 1 indicates that the operation mode of the network device is switched, and a value 0 indicates that the operation mode of the network device is not switched.

TABLE 1

| Bit | |
|---|---|
| number | Short message |
| 1 | System information modification |
| | (systemInfoModification) bit |
| | If this bit is set to 1, a modification |
| | of a broadcast control channel (BCCH) |
| | other than a SIB 6, a SIB 7, and a SIB 8 is indicated. |
| 2 | Earthquake and tsunami warning |
| | system (ETWS) and commercial mobile |
| | alert system (CMAS) indication |
| | (etwsAndCmasIndication) bit |
| | If this bit is set to 1, an ETWS |
| | primary notification, an ETWS secondary |
| | notification, and/or a CMAS notification are/is indicated. |
| 3 | Stop paging monitoring (stopPagingMonitoring) bit |
| | This bit can be used only for a shared |
| | spectrum channel access operation, and |
| | the SSB is required to include a |
| | monitoring occasion (nrofPDCCH- |
| | MonitoringOccasionPerSSB-InPO). |
| | If this bit is set to 1, it indicates that a UE |
| | can stop monitoring a PDCCH for |
| | paging messages in a current PO. |
| 4 | System information modification |
| | extended discontinuous reception (eDRX) |
| | (systemInfoModification-eDRX) bit |
| | If this bit is set to 1, a modification of a |
| | BCCH other than the SIB 6, the SIB |
| | 7, and the SIB 8 is indicated. This |
| | indication applies only to a UE that uses an |
| | eDRX cycle longer than a BCCH modification cycle. |
| 5 | Network device operation mode |
| | modification (bsTransModeModification) bit |
| | If this bit is set to 1, switching of the |
| | operation mode of the network device is |
| | indicated. |
| 6 to 8 | Not used |

In addition, the field may alternatively directly indicate the operation mode. For example, a value 0 of the field indicates the first operation mode, and a value 1 indicates the second operation mode. In this case, the field is used to carry the first information. In addition, the field may alternatively indicate whether the operation mode of the network device is switched. The implementation would be the same as the implementation in which the second information is carried by using the group DCI. Details are not described again.

The SIB message may explicitly or implicitly indicate the operation mode of the network device. For example, the SIB message may include an information element used to carry the operation mode information, to explicitly represent the current operation mode of the network device. For example, a value 0 of the information element indicates that the current operation mode of the network device is the first operation mode, and a value 1 indicates that the current operation mode of the network device is the second operation mode. In this case, the information element is used to carry the first information. For another example, the configuration information broadcast in the SIB message is related to the first operation mode of the network device, and it indicates that the network device is currently in the first operation mode; or the configuration information broadcast in the SIB message is related to the second operation mode of the network device, and it indicates that the network device is currently in the second operation mode.

(2) In another possible implementation, the operation mode information may be determined by the terminal apparatus based on a signal from the network device. The signal may indicate the current operation mode of the network device (that is, the operation mode information may be the first information), or may indicate that the operation mode of the network device is switched (that is, the operation mode information may be the second information).

For example, as described above, the network device may send a different synchronization signal in the first operation mode or the second operation mode, and the terminal apparatus may perform blind detection on a synchronization signal sent by the network device, and obtain the first information based on a blind detection result. For example, the terminal apparatus may blindly detect, based on configuration information in the first operation mode, the synchronization signal corresponding to the first operation mode. If detecting the synchronization signal (the PSS shown in FIG. 3) corresponding to the first operation mode, the terminal apparatus determines that the current operation mode of the network device is the first operation mode. In this case, the terminal apparatus may obtain the first information, where the first information indicates that the current operation mode of the network device is the first operation mode; or if not detecting the synchronization signal (for example, the SSB shown in FIG. 3) corresponding to the first operation mode, the terminal apparatus may blindly detect the synchronization signal in the second operation mode based on configuration information in the second operation mode. An example in which the synchronization signal corresponding to the first operation mode is first blindly detected is used herein for description. In addition, in actual application, the synchronization signal corresponding to the second operation mode may be first blindly detected, and when the synchronization signal is not detected, the synchronization signal corresponding to the first operation mode is then blindly detected. Alternatively, the terminal apparatus may blindly detect the synchronization signal corresponding to the first operation mode and the synchronization signal corresponding to the second operation mode at the same time, and determine a corresponding operation mode by detecting a corresponding synchronization signal.

(3) In another implementation, for a case in which the operation mode is periodically switched, the operation mode information may be switching cycle information (for example, at least one of a cycle, a duration, and an offset) of the operation mode. Because the switching cycle information may be used to determine operation mode switching, the switching cycle may also be considered as the second information. The cycle may be a cycle in which each operation mode occurs. The duration may be a duration of each operation mode. The offset may be a time interval between a start location of each operation mode and a start location of a complete switching cycle of the operation mode. The start location of the switching cycle may be a predefined value. For example, a slot 0 of a radio frame 0 is used as a start moment of a switching cycle. As shown in FIG. 6, a coordinate location O of a time (t) axis is a start location of a switching cycle, for example, a start moment of the slot 0 of the radio frame 0.

Optionally, the network device may send configuration information to the terminal apparatus, where the configuration information may be used to carry the switching cycle information. Optionally, refer to the descriptions of Manner 1 or Manner 2. The network device may send the configuration information to the terminal apparatus in the broadcast manner, the multicast manner, or the point-to-point manner. In addition, the switching cycle information may alternatively be defined in the protocol. Alternatively, the switching cycle information may be pre-stored locally in the terminal apparatus, for example, stored in a factory configuration of the terminal apparatus or a subscriber identity module (SIM) card.

Therefore, it may also be understood that in this implementation, the network device may send the operation mode information to the terminal apparatus. The operation mode information may be indicated by the network device, and an indication manner includes but is not limited to indication by using a message such as an RRC message, a MAC CE, DCI, a paging message, or a SIB message. Alternatively, the operation mode information may be defined in the protocol or pre-stored locally in the terminal apparatus.

S102: The terminal apparatus performs communication with the network device based on the operation mode information by using configuration information in one of the first operation mode or the second operation mode.

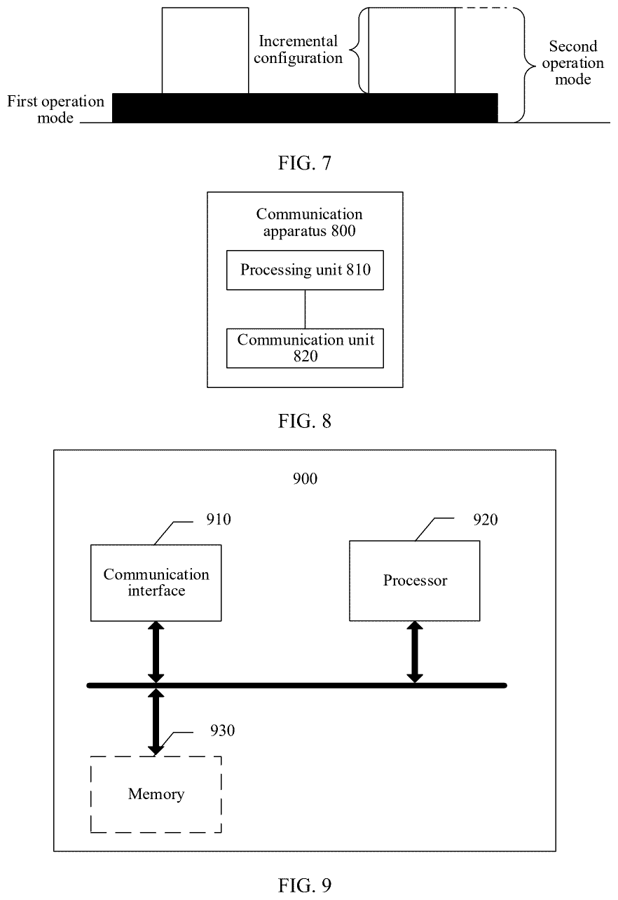

In this application, a switching manner for the operation mode of the network device includes at least two manners shown in FIG. 6 and FIG. 7. The switching manner shown in FIG. 6 may be referred to as a full switching manner. To be specific, the network device stops communication with the terminal apparatus in the process of switching between the first operation mode and the second operation mode. The switching manner shown in FIG. 7 may be referred to as a nested switching manner. To be specific, the first operation mode of the network device is still in an enabled state, and the network device only needs to additionally enable an incremental configuration in the second operation mode.

Specifically, as shown in FIG. 6, in a possible periodic switching manner, the operation mode of the network device is switched between the first operation mode and the second operation mode. For ease of description subsequently, the time (or the delay) of switching between operation modes of the network device is referred to as a first duration. Therefore, the network device stops communication with the terminal apparatus in the first duration in which the operation mode is switched, or the network device performs, after the first duration after the operation mode starts to be switched, communication with the terminal apparatus by using configuration information in an operation mode that is switched to. For the terminal apparatus, the terminal apparatus may perform, after the first duration that starts when the terminal apparatus determines that the operation mode of the network device is to be switched, communication with the network device by using the configuration information in the operation mode to be switched to. A manner in which the terminal apparatus determines that the operation mode of the network device is switched is, for example, determining, based on the second information, that the operation mode of the network device has been switched.

Optionally, a length of the first duration may be related to a system parameter (numerology) of an operating bandwidth of the terminal apparatus. The numerology is related to a subcarrier spacing and a cyclic prefix (CP). In addition, the length of the first duration may further be related to a quantity of antennas of the network device, a quantity of receive and transmit channels, or a cell bandwidth. It may be understood that a smaller value of the numerology, a larger quantity of antennas, a larger quantity of receive and transmit channels, or a larger cell bandwidth indicates a larger value of the first duration.

In a manner in which the terminal apparatus determines the first duration, the network device may send configuration information to the terminal apparatus, where the configuration information may carry indication information of the first duration. Refer to the descriptions of Manner 1 or Manner 2. The configuration information herein may be sent in the broadcast manner, the multicast manner, or the point-to-point manner. For example, the network device may carry the indication information of the first duration by using a switching indication for the operation mode. In addition, the first duration may alternatively be a value predefined in the protocol, or may be a value stored locally in the terminal apparatus.

For example, the first duration may include a plurality of preset values. For example, these preset values are predefined by using the protocol. During each switching, the preset value to be used as the first duration may be explicitly or implicitly indicated by the network device. For example, when the network device indicates mode switching by using signaling, the signaling may include indication information of a switching delay. Alternatively, the plurality of preset values of the first duration may be defined in the protocol and associated with the numerology. The terminal apparatus and/or the network device may determine a value of the first duration based on numerology in a current operating bandwidth. In this case, the value of the first duration does not need to be separately indicated.

In a possible implementation of operation mode switching, when a full switching solution is used, the network device may be associated with one or more antennas of all the antennas shown in FIG. 5. The one or more antennas may be associated with an ADC module and a DAC module that use a small quantity of quantization bits, and may be associated with a PA with low power consumption. When the network device determines to switch to the second operation mode, the network device may switch from the associated antennas to all the antennas in the first duration. All the antennas may be associated with an ADC module and a DAC module that use a large quantity of quantization bits, and may be associated with a PA with high power consumption.

As shown in FIG. 7, in another possible periodic switching manner (that is, the nested switching manner) of the operation mode, the first operation mode of the network device is in an enabled state, and the network device needs to send the common information in the first operation mode. When the second operation mode is enabled, the network device needs to additionally send the common information in the second operation mode in addition to the common information in the first operation mode. Similarly, the function supported by the network device in the first operation mode is still supported in the second operation mode. Therefore, in the second operation mode, the network device only needs to enable an additional function in the second operation mode, and does not need to disable or re-enable the function or functions in the first operation mode. In addition, the configuration such as the resource of the network device in the first operation mode is still applicable to the second operation mode. In the second operation mode, the network device only needs to enable an additional configuration in the second operation mode.

In other words, in the switching manner shown in FIG. 7, the network device may maintain communication in the first operation mode, without interrupting communication in the first operation mode. Therefore, compared with the manner shown in FIG. 6, there is no total interruption of communication, so that the delay due to mode switching can be reduced. Similarly, when the operation mode of the network device is switched from the second operation mode to the first operation mode, the network device only needs to disable the incremental configuration in the second operation mode relative to the first operation mode. Therefore, there is no interruption of communication, or in other words, the terminal apparatus and the network device may still communicate with each other by using the configuration information in the first operation mode.

In a possible implementation of operation mode switching, when a nested switching solution is used, the network device may be associated with some of all the antennas shown in FIG. 5. These antennas may be associated with an ADC module and a DAC module that use a small quantity of quantization bits, and may be associated with a PA with low power consumption. When the network device determines to switch to the second operation mode, the network device may additionally associate the other antennas in the first duration in an incremental manner, so that the antennas associated with the network device are changed to all the antennas of the network device. In addition, the network device may be associated, in an incremental manner, with an ADC and a DAC that use a large quantity of quantization bits. The network device may be further associated with a PA with high power consumption in an incremental manner.

In this application, because cycles, types, and the like of common information sent by the network device in different operation modes may be different, if a neighboring station cannot obtain the current operation mode of the network device in time, neighboring cell measurement is affected. Therefore, operation mode information of network devices needs to be exchanged between different network devices. Optionally, configuration information of the network devices in current operation modes (or each operation mode of the network devices) may be further exchanged. For example, the first network device sends configuration information in a current operation mode to the second network device based on a sending cycle or after entering the current operation mode, where the configuration information includes information such as a signal class for sending common information, a quantity of repetition times, or a sending cycle (or a sending interval) of the common information.

It may be understood that the operation mode of the network device affects not only measurement, but also some other functions. For example, for the network device in the first operation mode, the neighboring station does not add the network device to a CHO list, that is, the CHO list delivered by the neighboring station to a terminal covered by the neighboring station does not include a cell in the first operation mode, and does not use the cell as a target base station during CHO.

In a possible implementation, the network device may broadcast a frame number, an offset, a duration of the first operation mode, and a duration of the second operation mode by using system information. The offset is an interval between a start moment of the first operation mode and/or the second operation mode and a start moment of a cycle.

In another possible implementation, the network device may define different timers for different operation modes. The duration of these timers may be indicated by using system information or the like, or may be predefined by using the protocol. After a timer corresponding to an operation mode expires, the terminal apparatus and the network device switch the operation mode corresponding to the timer to another operation mode.

In another possible implementation, the network device may alternatively support a combination of periodic mode switching and mode switching triggered based on the switching indication. For example, during periodic mode switching, when the timer does not expire or the duration of the current operation mode does not expire, the terminal apparatus may trigger mode switching in advance by using signaling.

In addition, switching of the operation mode of the network device may alternatively be triggered by the terminal apparatus.

In a possible implementation in which the terminal apparatus triggers operation mode switching, when the function of the network device in the first operation mode does not meet a communication requirement of the terminal apparatus, the terminal apparatus may request the network device to switch to the second operation mode.

For example, it is assumed that the first operation mode of the network device supports paging but does not support data transmission. When the terminal apparatus has a data transmission request, the terminal apparatus may send an uplink signal to the network device. The uplink signal may indicate that there is a data transmission requirement, or is used to request the network device to switch to the second operation mode. The network device may decide, based on the uplink signal, to switch to the second operation mode.

For another example, the network device supports only service transmission whose rate is lower than a threshold and whose delay is higher than a threshold. When the terminal apparatus has a data transmission requirement, the terminal apparatus may send an uplink signal to the network device. The uplink signal is bound to a quality of service (QOS). The network device may determine, based on the received uplink signal, the QoS required by the terminal apparatus, and further determine, based on the QoS required by the terminal apparatus and an operation mode configuration, whether to switch to the second operation mode. For example, when the QoS supported by the network device in the first operation mode cannot meet the QoS required by the terminal apparatus, the network device may switch to the second operation mode.

Specifically, when the QOS required by the terminal apparatus includes a rate higher than the rate threshold, or includes a delay lower than the delay threshold, the network device may switch to the second operation mode, and perform data transmission with the terminal apparatus in the second operation mode, to meet the QoS requirement of the terminal apparatus. The uplink signal may be a preamble or another uplink signal. Alternatively, the uplink signal may be an RRC message, for example, auxiliary information of the UE. A binding relationship between the uplink signal and the QoS may be indicated by the network device to the terminal apparatus by using an RRC message, a MAC CE, DCI, a paging message, a SIB message, or the like, or may be predefined. This is not specifically limited in this application.

It can be learned that the network device supports operation mode switching based on the QoS requirement of the terminal apparatus, and this switching manner may also be referred to as switching based on auxiliary information of the terminal apparatus. In switching based on the auxiliary information, the network device may determine the operation mode based on the auxiliary information. In an implementation, the terminal apparatus may send auxiliary information to the network device. Alternatively, similar to the foregoing uplink signal manner, the terminal apparatus may send a signal related to the auxiliary information to the network device, so that the network device determines the auxiliary information based on the signal.

It may be understood that in this application, the auxiliary information of the terminal apparatus may include information about an operation mode of the network device expected by the terminal apparatus, a request for the operation mode of the network device, service requirement information, or communication performance requirement information.

The information about the operation mode expected by the terminal apparatus indicates, for example, an operation mode in which the terminal apparatus expects the network device to operate. For example, knowing the configuration information of the network device in each operation mode, the terminal apparatus may determine one of a plurality of operation modes of the network device as the expected operation mode based on a service requirement. In this case, the terminal apparatus may indicate the expected operation mode by using the auxiliary information. In addition, the terminal apparatus may send an operation mode request to the network device, to request the network device to switch to the operation mode expected by the terminal apparatus.

The service requirement information is, for example, a function, QoS, or slice information required by a service of the terminal apparatus.

The communication performance requirement information is, for example, a communication performance indicator that the service of the terminal apparatus needs to meet, for example, a service rate requirement and a service delay requirement.

Optionally, the auxiliary information may be included in an uplink message (such as the RRC message) or information of the terminal apparatus, or may correspond to the uplink signal sent by the terminal apparatus.

Optionally, the network device may further have a third operation mode or include a third operation mode and more operation modes. Refer to the descriptions of the first operation mode and the second operation mode. In the first operation mode, the second operation mode, the third operation mode, or other operation modes, overheads of transmission resources for the network device are different, functions supported by the network device are different, or access procedures are different. For example, in a possible implementation, energy consumption of the network device in the third operation mode is lower than energy consumption of the network device in the first operation mode.

Based on the same concept, an embodiment of this application further provides a communication apparatus. The communication apparatus may include corresponding hardware structures and/or software modules for performing the functions shown in the foregoing method. A person skilled in the art should easily understand that in this application, the units and method steps in the examples described with reference to embodiments disclosed herein can be implemented by hardware or a combination of hardware and computer software. Whether a function is performed by hardware or hardware driven by computer software depends on particular application scenarios and design constraint conditions of the technical solutions.

FIG. 8 to FIG. 10 are diagrams of the structures of possible communication apparatuses according to embodiments of this application. The communication apparatus may be configured to implement the functions of the terminal apparatus and/or the network device in the foregoing method embodiment. Therefore, beneficial effects of the foregoing method embodiment can also be implemented. In a possible implementation, the communication apparatus may be the terminal device or the network device shown in FIG. 1. For related details and effects, refer to the descriptions in the foregoing embodiments.

As shown in FIG. 8, a communication apparatus 800 includes a processing unit 810 and a communication unit 820. The communication unit 820 may alternatively be a transceiver unit, an input/output interface, or the like. The communication apparatus 800 may be configured to implement the functions of the terminal apparatus and/or the network device in the method embodiment shown in FIG. 2.

When the method performed by the terminal apparatus shown in FIG. 2 is implemented, the processing unit 810 may be configured to obtain operation mode information of a network device. The communication unit 820 may be configured to perform communication with the network device based on the operation mode information by using configuration information in one of a first operation mode or a second operation mode.

Optionally, the communication unit 820 may be further configured to receive configuration information in the first operation mode and/or configuration information in the second operation mode from the network device.

Optionally, the communication unit 820 may be further configured to perform, after the first duration starting when the processing unit 810 determines that an operation mode of the network device is to be switched, communication with the network device by using configuration information in an operation mode that is switched to.

Optionally, the communication unit 820 may be further configured to receive a first synchronization signal, and initiate random access based on the first synchronization signal; or configured to receive a second synchronization signal, and initiate random access based on the second synchronization signal. A sequence length of the first synchronization signal is less than a sequence length of the second synchronization signal; and/or a sequence type of the first synchronization signal is different from a sequence type of the second synchronization signal.

Optionally, the processing unit 810 may be further configured to determine the operation mode information based on the first synchronization signal, or determine the operation mode information based on the second synchronization signal.

Optionally, the processing unit 810 may be further configured to perform downlink synchronization based on the first synchronization signal. The communication unit 820 may be further configured to send a first message to the network device, receive a master information block and system information from the network device, and send a random access request to the network device based on an access configuration and a random access resource configuration.

Optionally, the processing unit 810 may be further configured to perform downlink synchronization based on the second synchronization signal. The communication unit 820 may be further configured to receive a master information block and system information, and send a random access request to the network device based on an access configuration and a random access resource configuration.

Optionally, the communication unit 820 may be further configured to send auxiliary information or a signal associated with auxiliary information.

When the method performed by the network device shown in FIG. 2 is implemented, the processing unit 810 may be configured to determine operation mode information. The communication unit 820 may be configured to perform communication with a terminal apparatus based on the operation mode information by using configuration information in one of a first operation mode or a second operation mode.

Optionally, the communication unit 820 may be further configured to send configuration information in the first operation mode and/or configuration information in the second operation mode.

Optionally, the communication unit 820 may be further configured to perform, after the first duration starting when the processing unit 810 determines to switch an operation mode, communication with the terminal apparatus by using configuration information in an operation mode after switching.

Optionally, the communication unit 820 may be further configured to send a first synchronization signal and/or a second synchronization signal. The sequence length of the first synchronization signal is less than the sequence length of the second synchronization signal; and/or a sequence type of the first synchronization signal is different from a sequence type of the second synchronization signal.

Optionally, the communication unit 820 may be further configured to receive a first message, and send a master information block and system information.

Optionally, the communication unit 820 may be further configured to receive a random access request.

Optionally, the communication unit 820 may be further configured to receive auxiliary information from the terminal apparatus, and the processing unit 810 may be further configured to determine the operation mode of the network device based on the auxiliary information.

For actions implemented by the processing unit 810 and the communication unit 820, refer to the descriptions of the corresponding actions in the foregoing method embodiment. Details are not described herein again.

It may be understood that in embodiments of this application, the division into modules is merely an example used for illustration purposes, and in some embodiments, may be logical function division. In an actual implementation, there may be a different division manner. In addition, functional modules in embodiments of this application may be integrated into one processor, or each module may exist alone physically, or two or more modules may be integrated into one module. The integrated module may be implemented in a form of hardware, or in a form of software functional modules, or in a form of hardware combined with software.

FIG. 9 shows a communication apparatus 900 according to an embodiment of this application, which is configured to implement communication methods provided in this application. The communication apparatus 900 may be a communication apparatus to which the communication method is applied, may be a component in a communication apparatus, or may be an apparatus that can be matched with a communication apparatus for use. The communication apparatus 900 may be a terminal apparatus and/or a network device. The communication apparatus 900 may be a chip system or a chip. In some embodiments of this application, the chip system may include a chip, or may include a chip and another discrete component. The communication apparatus 900 includes at least one processor 920 configured to implement the communication method provided in embodiments of this application. The communication apparatus 900 may further include a communication interface 910, configured to input and/or output a signal. The communication interface 910 may be an input/output interface (including an input interface and/or an output interface), a transceiver, an interface circuit, or the like. The communication interface 910 may be configured to communicate with another apparatus. For example, when being a chip or a chip system (SoC), the communication apparatus 900 performs transmission with another chip or component via the communication interface 910. For another example, as a baseband unit, the communication apparatus 900 may communicate with a radio frequency unit via the communication interface 910, where the baseband unit may be connected to the radio frequency unit. For another example, when the communication apparatus 900 is a terminal device or a network device, the communication interface 910 may be a transceiver configured to send and/or receive a signal.

For example, the processor 920 may be configured to perform an action performed by the processing unit 810, and the communication interface 910 may be configured to perform an action performed by the communication unit 820. Details are not described again.

Optionally, the communication apparatus 900 may further include at least one memory 930 configured to store program instructions and/or data. The memory 930 is coupled to the processor 920. The coupling in this embodiment of this application may be an indirect coupling or a communication connection between apparatuses, units, or modules in an electrical form, a mechanical form, or another form, and is used for information exchange between the apparatuses, the units, or the modules. The processor 920 may operate in collaboration with the memory 930. The processor 920 may execute the program instructions stored in the memory 930. At least one memory in the at least one memory may be integrated with the processor.

In some embodiments of this application, the memory 930 may be a non-volatile memory such as a hard disk drive (HDD) or a solid-state drive (SSD), or may be a volatile memory such as a random access memory (RAM). The memory 930 is any medium that can be configured to carry or store expected program code in the form of an instruction or a data structure and that can be accessed by a computer, but is not limited thereto. The memory 930 in some embodiments of this application may alternatively be a circuit or any other apparatus that can implement a storage function, and is configured to store the program instructions and/or the data.

In some embodiments of this application, the processor 920 may be a baseband processor, a general-purpose processor, a digital signal processor, an application-specific integrated circuit, a field programmable gate array or another programmable logic device, a discrete gate or transistor logic device, or a discrete hardware component, and may implement or perform the method, steps, and logical block diagrams disclosed in embodiments of this application. The general-purpose processor may be a microprocessor, any conventional processor, or the like. The steps of the method disclosed with reference to embodiments of this application may be directly performed by a hardware processor, or may be performed by using a combination of hardware in the processor and a software module.

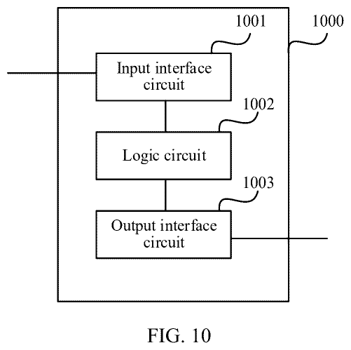

FIG. 10 shows a communication apparatus 1000 according to an embodiment of this application, which is configured to implement the communication methods provided in this application. The communication apparatus 1000 may be a communication apparatus to which the communication method shown in embodiments of this application is applied, may be a component in a communication apparatus, or may be an apparatus that can be matched with a communication apparatus for use. The communication apparatus 1000 may be a terminal apparatus and/or a network device. The communication apparatus 1000 may be a chip system or a chip. In some embodiments of this application, the chip system may include a chip, or may include a chip and another discrete component. The communication method provided in the foregoing embodiments may be partially or completely implemented by hardware or software. When the communication method is implemented by hardware, the communication apparatus 1000 may include an input interface circuit 1001, a logic circuit 1002, and an output interface circuit 1003.

Optionally, an example in which the apparatus is configured to implement a function of a receive end is used. The input interface circuit 1001 may be configured to perform a receiving action performed by the communication unit 820. The output interface circuit 1003 may be configured to perform a sending action performed by the communication unit 820. The logic circuit 1002 may be configured to perform an action performed by the processing unit 810. Details are not described again.

Optionally, in a specific implementation, the communication apparatus 1000 may be a chip or an integrated circuit.

Some or all of operations and functions performed by the communication apparatus described in the foregoing method embodiments of this application may be implemented by using the chip or the integrated circuit.

An embodiment of this application provides a computer-readable storage medium storing a computer program. The computer program includes instructions for performing the methods in the foregoing method embodiments.

An embodiment of this application provides a computer program product including instructions. The instructions, when run on a computer, cause the computer to perform the methods in the foregoing method embodiments.

An embodiment of this application further provides a communication system, including the foregoing terminal apparatus and/or network device. For example, the terminal apparatus may be configured to perform the method shown in FIG. 2.

It may be understood that the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor.

All or some of the foregoing embodiments may be implemented by software, hardware, firmware, or any combination thereof. When software is used to implement the foregoing embodiments, all or some of the foregoing embodiments may be implemented in a form of a computer program product. The computer program product includes one or more computer instructions. When the computer instructions are loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk drive, or a magnetic tape), an optical medium (for example, a high-density digital video disc (DVD)), a semiconductor medium (for example, an SSD), or the like.

It should be noted that parts of this patent application document include copyright-protected content. Except for making copies of the patent documents of the Patent Office or recorded content of the patent documents, the copyright owner reserves the copyright.

The network device and the terminal device in the foregoing apparatus embodiments correspond to the network device or the terminal device in the method embodiments. A corresponding module or unit performs a corresponding step. For example, the communication unit (the transceiver) performs a receiving step or a sending step in the method embodiments, and a step other than the sending step and the receiving step may be performed by the processing unit (the processor). For a function of a specific unit, refer to a corresponding method embodiment. There may be one or more processors.

Terms such as “component”, “module”, and “system” used in this specification are used to indicate computer-related entities, hardware, firmware, combinations of hardware and software, software, or software in execution. For example, a component may be but is not limited to a process that is run on a processor, a processor, an object, an executable file, an execution thread, a program, and/or a computer. As illustrated by using figures, both a computing device and an application that is run on the computing device may be components. One or more components may reside within a process and/or an execution thread, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from two components interacting with another component in a local system, a distributed system, and/or across a network such as an internet interacting with other systems by using the signal).

A person of ordinary skill in the art should understand that each illustrative logical block and step described with reference to embodiments disclosed in this specification may be implemented by electronic hardware or a combination of computer software and electronic hardware. Whether the functions are performed by hardware or software depends on particular applications and design constraints of the technical solutions. A person skilled in the art may use different methods to implement the described functions for each particular application, which should not be considered as beyond the scope of this application.

It may be clearly understood by a person skilled in the art that for the purpose of convenient and brief description, for a detailed working process of the foregoing system, apparatus, and unit, refer to a corresponding process in the foregoing method embodiment. Details are not described herein again.

In the several embodiments provided in this application, it should be understood that the disclosed system, apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the functional units may exist alone physically, or two or more functional units are integrated into one unit. When functions are implemented in the form of a software functional unit and sold or used as an independent product, the functions may be stored in a computer-readable storage medium.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
obtaining, by a terminal apparatus, operation mode information of a network apparatus, wherein an operation mode of the network apparatus comprises one of a first operation mode or a second operation mode, the first operation mode and the second operation mode belong to a same radio access technology (RAT), and the first operation mode and the second operation mode satisfy at least one of the following:
overheads of a transmission resource for a synchronization signal of the network apparatus in the first operation mode are lower than overheads of a transmission resource for a synchronization signal of the network apparatus in the second operation mode;
a function supported by the network apparatus in the first operation mode is a proper subset of a function supported by the network apparatus in the second operation mode; or
an access procedure in the first operation mode is different from an access procedure in the second operation mode; and
performing, by the terminal apparatus, communication with the network apparatus based on the operation mode information by using configuration information in one of the first operation mode and the second operation mode.

2. The method according to claim 1, wherein the function supported by the network apparatus in the second operation mode comprises at least one of the following:
a dual active protocol stack, conditional handover, two-step random access, small data transmission, a reduced capability, vehicle-to-everything, a multicast broadcast service, slicing, an industrial internet of things, extended reality, uplink data compression, positioning, ultra-reliable low-latency communication, high-order modulation, grant-free scheduling, sensing, artificial intelligence, unlicensed spectrum transmission, multi-layer transmission, or non-slot scheduling.

3. The method according to claim 1, wherein the method further comprises:
receiving, by the terminal apparatus, configuration information in the first operation mode or configuration information in the second operation mode from the network apparatus.

4. The method according to claim 1, wherein the operation mode information comprises at least one of the following:
first information indicating one of the first operation mode and the second operation mode; or
second information relating to switching of the operation mode of the network apparatus.

5. The method according to claim 4, wherein the second information comprises at least one of the following information:
a cycle and a duration of the first operation mode;
a cycle and a duration of the second operation mode; or
information indicating operation mode switching.

6. The method according to claim 1, wherein the operation mode information is carried in one or more of group downlink control information (DCI), a paging message, a short message, or a system information block (SIB).

7. The method according to claim 1, wherein
a modulation and coding scheme (MCS) table associated with the first operation mode is different from a modulation and coding scheme (MCS) table associated with the second operation mode; and/or
a channel quality information (CQI) table associated with the first operation mode is different from a channel quality information (CQI) table associated with the second operation mode.

8. The method according to claim 1, wherein the method further comprises:
performing, by the terminal apparatus after a first duration starting from when the terminal apparatus determines that the operation mode of the network apparatus is to be switched, communication with the network apparatus by using configuration information in an operation mode that is switched to.

9. The method according to claim 8, wherein the first duration is related to a system parameter numerology within an operating bandwidth of the terminal apparatus.

10. The method according to claim 8, wherein the first duration is comprised in a switching indication for the operation mode of the network apparatus.

11. The method according to claim 1, wherein the method further comprises:
receiving, by the terminal apparatus, a first synchronization signal or a second synchronization signal, wherein the first or second synchronization signal corresponds to the first or second operation mode respectively; and
initiating, by the terminal apparatus, random access based on the first synchronization signal or the second synchronization signal; wherein
a sequence length of the first synchronization signal is less than a sequence length of the second synchronization signal; or a sequence type of the first synchronization signal is different from a sequence type of the second synchronization signal.

12. The method according to claim 11, wherein the method further comprises:
determining, by the terminal apparatus, the operation mode information based on the first synchronization signal; or
determining, by the terminal apparatus, the operation mode information based on the second synchronization signal.

13. The method according to claim 11, wherein the initiating, by the terminal apparatus, of random access based on the first synchronization signal comprises:
performing, by the terminal apparatus, downlink synchronization based on the first synchronization signal;
sending, by the terminal apparatus, a first message to the network apparatus, wherein the first message is used to request the network apparatus to send a master information block and system information;
receiving, by the terminal apparatus, the master information block and the system information from the network apparatus, wherein the master information block comprises an access configuration, and the system information comprises a random access resource configuration; and
sending, by the terminal apparatus, a random access request to the network apparatus based on the access configuration and the random access resource configuration.

14. The method according to claim 11, wherein the initiating, by the terminal apparatus, of random access based on the second synchronization signal comprises:
performing, by the terminal apparatus, downlink synchronization based on the second synchronization signal;
receiving, by the terminal apparatus, a master information block and system information from the network apparatus, wherein the master information block comprises an access configuration, and the system information comprises a random access resource configuration; and
sending, by the terminal apparatus, a random access request to the network apparatus based on the access configuration and the random access resource configuration.

15. The method according to claim 1, wherein the method further comprises:
sending, by the terminal apparatus, auxiliary information or a signal associated with auxiliary information to the network apparatus, wherein the auxiliary information is used by the network apparatus to determine the operation mode; and
the auxiliary information comprises at least one of the following information:
information about an operation mode expected by the terminal apparatus, a request for the operation mode, service requirement information, or communication performance requirement information.

16. A communication method, comprising:
determining, by a network apparatus, operation mode information, wherein an operation mode of the network apparatus comprises one of a first operation mode or a second operation mode, the first operation mode and the second operation mode belong to a same radio access technology (RAT), and the first operation mode and the second operation mode satisfy at least one of the following: overheads of a transmission resource for a synchronization signal of the network apparatus in the first operation mode are lower than overheads of a transmission resource for a synchronization signal of the network apparatus in the second operation mode;
a function supported by the network apparatus in the first operation mode is a proper subset of a function supported by the network apparatus in the second operation mode; or an access procedure in the first operation mode is different from an access procedure in the second operation mode; and
performing, by the network apparatus, communication with a terminal apparatus based on the operation mode information by using configuration information in one of the first operation mode or the second operation mode.

17. The method according to claim 16, wherein the function supported by the network apparatus in the second operation mode comprises at least one of the following:
a dual active protocol stack, conditional handover, two-step random access, small data transmission, a reduced capability, vehicle-to-everything, a multicast broadcast service, slicing, an industrial internet of things, extended reality, uplink data compression, positioning, ultra-reliable low-latency communication, high-order modulation, grant-free scheduling, sensing, artificial intelligence, unlicensed spectrum transmission, multi-layer transmission, or non-slot scheduling.

18. The method according to claim 16, wherein the method further comprises:
sending, by the network apparatus, configuration information in the first operation mode or configuration information in the second operation mode.

19. The method according to claim 16, wherein the operation mode information comprises at least one of the following:
first information indicating one of the first operation mode and the second operation mode; or
second information relating to switching of the operation mode of the network apparatus.

20. A communication apparatus, comprising a processor, wherein the processor is configured to read an instruction in a memory, and perform:
obtaining, by a terminal apparatus, operation mode information of a network apparatus, wherein an operation mode of the network apparatus comprises one of a first operation mode or a second operation mode, the first operation mode and the second operation mode belong to a same radio access technology (RAT), and the first operation mode and the second operation mode satisfy at least one of the following:
overheads of a transmission resource for a synchronization signal of the network apparatus in the first operation mode are lower than overheads of a transmission resource for a synchronization signal of the network apparatus in the second operation mode;
a function supported by the network apparatus in the first operation mode is a proper subset of a function supported by the network apparatus in the second operation mode; or
an access procedure in the first operation mode is different from an access procedure in the second operation mode; and
performing, by the terminal apparatus, communication with the network apparatus based on the operation mode information by using configuration information in one of the first operation mode and the second operation mode.
